(19) United States
(12) Patent Application Publication
(10) Pub. No.: US 2026/0129521 A1
(43) Pub. Date: May 7, 2026

(54) TERRESTRIAL NETWORK TO NON-TERRESTRIAL NETWORK MOBILITY

(71) Applicant: QUALCOMM Incorporated, San Diego, CA (US)

(72) Inventors: Bharat SHRESTHA, San Diego, CA (US); Jae Ho RYU, San Diego, CA (US); Chiranjib SAHA, Lakeside, CA (US); Changhwan PARK, San Diego, CA (US)

(21) Appl. No.: 19/372,514

(22) Filed: Oct. 29, 2025

Related U.S. Application Data
(60) Provisional application No. 63/716,613, filed on Nov. 5, 2024.

(51) Int. Cl. H04W 36/00; H04W 56/00; H04W 84/06

(52) U.S. Cl. CPC H04W 36/0022; H04W 56/0015; H04W 84/06

(57) ABSTRACT

Various aspects of the present disclosure generally relate to wireless communication. In some aspects, a first network entity may receive, from a second network entity, first information associated with terrestrial network to non-terrestrial network (TN-to-NTN) mobility, wherein the second network entity is configured to support a terrestrial network cell. The first network entity may perform, in accordance with the first information, an action associated with TN-to-NTN mobility. Numerous other aspects are described.

### CROSS-REFERENCE TO RELATED APPLICATION

This Patent Application claims priority to U.S. Provisional Patent Application No. 63/716,613, filed on November 5, 2024, entitled “TERRESTRIAL NETWORK TO NON-TERRESTRIAL NETWORK MOBILITY,” and assigned to the assignee hereof. The disclosure of prior Provisional Patent Application No. 63/716,613 is considered part of and is incorporated by reference into this Patent Application in its entirety.

### FIELD OF THE DISCLOSURE

Aspects of the present disclosure generally relate to wireless communication and specifically relate to techniques, apparatuses, and methods associated with terrestrial network to non-terrestrial network mobility.

### INTRODUCTION

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

### SUMMARY

In some aspects, a first network entity includes a processing system configured to: receive, from a second network entity, first information associated with terrestrial network to non-terrestrial network (TN-to-NTN) mobility, wherein the second network entity is configured to support a terrestrial network cell; and perform, in accordance with the first information, an action associated with TN-to-NTN mobility.

In some aspects, a first network entity includes a processing system configured to: transmit, to a second network entity, first information associated with TN-to-NTN mobility, wherein the first network entity is configured to support a terrestrial network cell; and perform, in accordance with the first information, an action associated with TN-to-NTN mobility.

In some aspects, a method of wireless communication performed by a first network entity includes receiving, from a second network entity, first information associated with TN-to-NTN mobility, wherein the second network entity is configured to support a terrestrial network cell; and performing, in accordance with the first information, an action associated with TN-to-NTN mobility.

In some aspects, a method of wireless communication performed by a first network entity includes transmitting, to a second network entity, first information associated with TN-to-NTN mobility, wherein the first network entity is configured to support a terrestrial network cell; and performing, in accordance with the first information, an action associated with TN-to-NTN mobility.

In some aspects, a non-transitory computer-readable medium having code stored thereon that, when executed by a first network entity, cause the first network entity to: receive, from a second network entity, first information associated with TN-to-NTN mobility, wherein the second network entity is configured to support a terrestrial network cell; and perform, in accordance with the first information, an action associated with TN-to-NTN mobility.

In some aspects, a non-transitory computer-readable medium having code stored thereon that, when executed by a first network entity, cause the first network entity to: transmit, to a second network entity, first information associated with TN-to-NTN mobility, wherein the first network entity is configured to support a terrestrial network cell; and perform, in accordance with the first information, an action associated with TN-to-NTN mobility.

In some aspects, a first apparatus for wireless communication includes means for receiving, from a second apparatus, first information associated with TN-to-NTN mobility, wherein the second apparatus is configured to support a terrestrial network cell; and means for performing, in accordance with the first information, an action associated with TN-to-NTN mobility.

In some aspects, a first apparatus for wireless communication includes means for transmitting, to a second apparatus, first information associated with TN-to-NTN mobility, wherein the first apparatus is configured to support a terrestrial network cell; and means for performing, in accordance with the first information, an action associated with TN-to-NTN mobility.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing broadly outlines example features and example technical advantages of examples according to the disclosure. Additional example features and example advantages are described hereinafter.

### BRIEF DESCRIPTION OF THE DRAWINGS

The appended drawings illustrate certain example aspects of this disclosure and are therefore not limiting in scope. The same reference numbers in different drawings may identify the same or similar elements.

FIG. 1 is a diagram illustrating an example environment in which apparatuses and/or methods described herein may be implemented, in accordance with the present disclosure.

FIG. 2 is a diagram illustrating an example of a wireless communication network, in accordance with the present disclosure.

FIG. 3 is a diagram illustrating an example disaggregated network node architecture, in accordance with the present disclosure.

FIG. 4 is a diagram illustrating an example of a regenerative satellite deployment and an example of a transparent satellite deployment in a non-terrestrial network.

FIG. 5 is a diagram illustrating an example of a handover procedure, in accordance with the present disclosure.

FIG. 6 is a diagram of an example associated with terrestrial network to non-terrestrial network mobility, in accordance with the present disclosure.

FIG. 7 is a diagram illustrating an example process performed, for example, at a first network entity or an apparatus of a first network entity, in accordance with the present disclosure.

FIG. 8 is a diagram illustrating an example process performed, for example, at a first network entity or an apparatus of a first network entity, in accordance with the present disclosure.

FIG. 9 is a diagram of an example apparatus for wireless communication, in accordance with the present disclosure.

FIG. 10 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms. The present disclosure is not limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. The scope of the disclosure covers any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure covers an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

A radio access technology (RAT) may support non-terrestrial networks (NTNs). For example, a 5G or 6G RAT may support NTN deployments. In an NTN, coverage may be provided by a satellite. For example, the satellite may act as a gateway to a core network or data network. As another example, the satellite may act as an intermediary between a terrestrial gateway and at least one covered user equipment (UE), thereby increasing the coverage area of the network relative to providing coverage directly from the terrestrial gateway. NTNs may provide coverage of large geographic areas, including areas that are difficult for terrestrial networks (TNs) to cover (such as remote areas, oceans, or areas without established telecommunications operators), but may be associated with challenges that are not typical of TNs. For example, NTNs may generally have larger propagation delays, larger timing adjustments (TAs), and larger Doppler spreads than TNs due to high speed of the satellites and increased spatial separation between the satellites and the covered UEs.

A RAT may support mobility operations between network nodes (e.g., gNBs, cells, beams) of the RAT. One example of a mobility operation is a handover, in which an active connection and UE context is transferred from a first network node (e.g., providing a source primary cell (PCell)) to a second network node. Another example of a mobility operation is a primary secondary cell (PSCell) change, in which a PSCell of a UE (such as a UE using dual connectivity with a main cell group and a secondary cell group) is transferred from a first network node to a second network node. Another example of a mobility operation is a measurement operation of one or more neighbor cells or non-serving cells. For example, a UE may obtain measurement information (e.g., indicating a signal strength of one or more cells or network nodes, such as Layer 3 reference signal received power (RSRP) or reference signal received quality (RSRQ) measurements). For example, a serving or source network node may cause a UE to perform a handover operation to a given cell only if a measurement of the given cell satisfies a threshold (indicating that the given cell is suitable as a target cell for the mobility operation).

A handover operation in a wireless communication network is an operation that facilitates the seamless transition of an ongoing session for a UE from one cell or network node to another, ensuring uninterrupted service as the UE moves through different geographic areas. For example, the UE may perform a handover process to change a communication connection from a source network node to a target network node. During the handover operation, information (e.g., context information) for the UE may be provided from the source network node to the target network node to enable the target network node to establish a connection with the UE. The handover operation enables the UE to maintain active communication sessions in mobility scenarios (e.g., while the UE is moving) and/or in scenarios where a quality of a communication link with the source network node becomes poor. A handover operation may be performed or initiated based on various parameters, such as signal strength, quality of service, and/or the UE’s location relative to different network nodes. The process involves coordinating between the source network node and the target network node to manage resources and maintain optimal network performance.

In some examples, the wireless communication network may include one or more NTN deployments in which a non-terrestrial wireless communication device may include a network node (referred to herein as a “non-terrestrial network node”) and/or a relay station (referred to herein, interchangeably, as a “non-terrestrial relay station”). As used herein, “NTN” may refer to a network for which access is facilitated by a non-terrestrial network node and/or a non-terrestrial relay station. The wireless communication network may include any number of non-terrestrial wireless communication devices. A non-terrestrial wireless communication device may include a satellite and/or a high-altitude platform (HAP). A HAP may include a balloon, a dirigible, an airplane, and/or an unmanned aerial vehicle. A non-terrestrial wireless communication device may be part of an NTN that is separate from the wireless communication network. Alternatively, an NTN may be part of the wireless communication network. Satellites may communicate directly and/or indirectly with other entities in the wireless communication network using satellite communication. The other entities may include UEs, other satellites in the one or more NTN deployments, other types of network nodes (e.g., stationary or ground-based network nodes), relay stations, and/or one or more components and/or devices included in a core network of the wireless communication network.

In some examples, a UE may operate in a wireless communication network that supports both terrestrial network cells and NTN cells. In such examples, TN-to-NTN mobility scenarios may exist in which the UE performs a mobility operation for an NTN cell while operating in a terrestrial network cell (e.g., while the terrestrial network cell is the serving cell of the UE). For example, the UE may perform a handover operation from the terrestrial network cell to the NTN cell. Such handovers may be intra-system handovers (e.g., the terrestrial network cell and the NTN cell may be part of the same system and not considered different RATs). As used herein, “TN-to-NTN” mobility refers to a mobility operation for a UE to an NTN cell while a serving cell of the UE is a TN cell. “Serving” cell refers to a cell with which the UE has an active connected connection (e.g., a radio resource control (RRC) connected connection).

In some examples, the UE may be configured to perform measurements for NTN frequencies (e.g., frequencies configured for operation with an NTN cell) for connected mode measurements for a TN-to-NTN mobility operation. However, the UE may not have NTN cell information (e.g., satellite information, ephemeris information, an epoch time, timing advance information, and/or other information) for the NTN frequencies. In such examples, the UE may not perform NTN cell measurements due to the lack of NTN cell information (for example), and may not transmit measurement information for NTN cells to the serving cell of the terrestrial network. In such examples, the serving cell of the terrestrial network may determine to handover the UE to an NTN cell without measurement information for the NTN cell (e.g., a “blind” handover).

NTNs offer connectivity solutions for varied environments and scenarios, such as remote regions, emergency or disaster situations, military operations, and other areas where terrestrial networks may not reach or be efficient. NTNs often rely on satellite systems and leverage global navigation satellite system (GNSS) data for accurate UE positioning or location resolution, which enables devices operating in the NTN to maintain synchronization with the satellite. This is beneficial for communications associated with the NTN due to significant timing and frequency offsets encountered in signal propagation over large distances associated with communication links in an NTN.

However, a dependency on location resolution data (e.g., GNSS data) for a handover operation imposes challenges, such as when the UE is operating in a location resolution operational state in which the UE does not have access to location resolution data (e.g., due to the UE not supporting a GNSS capability or when the UE is temporarily operating without access to GNSS for one or more reasons, such as power saving). In such examples, the handover operation from a source network node to a target network node may be hindered or degraded by the absence of precise location and timing information, such as when the UE does not have access to location resolution data. This leads to complications in configuring random access resources and/or compensating timing and frequency adjustments during the handover operation, such as for a handover to an NTN cell. For example, the target network node (e.g., that supports the NTN cell) may assume that the UE has access to location resolution data during the handover operation and/or may not receive location resolution data (e.g., indicating the location or position of the UE) as part of the handover operation. This may degrade performance of the handover operation, such as for scenarios in which there are large timing and/or frequency offsets or adjustments for a communication link (e.g., NTN deployments, high-mobility scenarios (e.g., high-speed train scenarios), or other scenarios).

However, the UE operation without location resolution data (e.g., without access to data from a GNSS) may negatively impact the success of a handover from a terrestrial network cell to an NTN cell (e.g., because the NTN cell may be associated with significant timing and frequency offsets encountered in signal propagation over large distances associated with communication links in the NTN, and the UE and/or the NTN network node may be unable to effectively account for the timing and frequency offsets without the location resolution data). Therefore, in some examples, the UE may obtain location resolution data (e.g., from a GNSS) after receiving a handover command indicating that the UE is to establish a connection with the NTN cell. However, activating one or more components to enable the UE to communicate or receive signals from the GNSS and establishing a connection with the GNSS may take time. Due to the time associated with obtaining the location resolution data from the GNSS and/or searching for and synchronizing with the NTN cell, a handover failure timer (e.g., a T304 timer as defined, or otherwise fixed, by a wireless communication standard, such as the 3GPP) may expire before the UE is able to successfully complete the handover to the NTN cell, resulting in a failure of the handover. Further, because the serving cell (e.g., the terrestrial network cell) may initiate the handover without measurement information from the UE for the NTN cell, channel conditions between the UE and the NTN cell may be poor. This may result in the UE being handed over to an unsuitable target cell, degrading performance for the UE and consuming network resources associated with performing the handover operation.

Various aspects relate generally to enhancements for TN-to-NTN mobility. Some aspects more specifically relate to a first network entity (e.g., a UE) receiving, from a second network entity (e.g., a network node configured to support a terrestrial network cell), information associated with TN-to-NTN mobility. For example, the terrestrial network cell may be the serving cell for the first network entity. The information may include handover information. For example, the handover information may include a timer configured for TN-to-NTN handovers. The timer may be a handover failure timer. The timer may be configured for RRC reconfiguration for handovers (e.g., RRC reconfiguration with mobility control information) from a terrestrial network cell to an NTN cell. The timer may be, or may be similar to, the T304 timer and may be configured specifically for TN-to-NTN handovers. For example, the first network entity may be configured with a separate timer (e.g., a separate T304 timer) for terrestrial network to terrestrial network handovers. The timer configured for TN-to-NTN handovers may have a longer duration than the timer configured for terrestrial network to terrestrial network handovers.

Additionally, or alternatively, the information associated with TN-to-NTN mobility may include an amount of time configured for NTN cell synchronization. The first network entity may use the amount of time configured for NTN cell synchronization as an offset for a handover failure timer (e.g., a T304 timer, such as the timer(s) described above). For example, the first network entity may offset (or delay) an initiation of a handover failure timer by the amount of time configured for NTN cell synchronization for a handover operation from a terrestrial network cell to an NTN cell.

Additionally, or alternatively, the information associated with TN-to-NTN mobility may include a reference location of the first network entity for the TN-to-NTN mobility. In such examples, the first network entity may perform, using the reference location, one or more measurements associated with an NTN cell to obtain measurement information (e.g., measurement information associated with the NTN cell). The first network entity may transmit, and the second network entity may receive, the measurement information. In some aspects, the first network entity may perform a location resolution operation (e.g., may turn on a GNSS component) to obtain an estimated location of the first network entity. For example, the first network entity may determine (e.g., without receiving explicit instructions from the second network entity) to perform the location resolution operation based on the measurement information (e.g., based on one or more measurement values satisfying a threshold). As another example, the second network entity may determine that the first network entity is to perform the location resolution operation based on the measurement information and may transmit an indication, to the first network entity, to perform the location resolution operation. For example, during a handover preparation to the NTN cell, the second network entity may cause the first network entity to turn on a GNSS component to proactively obtain the estimated location of the first network entity.

Particular aspects of the subject matter described in this disclosure can be implemented to realize one or more of the following potential advantages. In some examples, the described techniques can be used to improve the likelihood of successful TN-to-NTN handovers. For example, by the first network entity receiving a handover failure timer configured for TN-to-NTN handovers, the first network entity may have more time to perform operations for the TN-to-NTN handovers (e.g., obtain location resolution data from a GNSS and/or search for and synchronize with the NTN cell) before the handover failure timer expires, because the duration of the handover timer may be configured to account for such operations (e.g., such operations that are specific to TN-to-NTN handovers). As another example, by the first network entity applying an offset to the initiation of a handover failure timer (e.g., where the offset is based on an amount of time configured for NTN cell synchronization), the first network entity may have more time to perform operations for the TN-to-NTN handovers, thereby increasing the likelihood of a successful handover to the NTN cell.

Additionally, or alternatively, by the first network entity receiving a reference location of the first network entity for the TN-to-NTN mobility, the first network entity may perform more accurate measurements for NTN cell(s) while the first network entity is connected to a terrestrial network cell. For example, this may enable the first network entity to search for and/or measure an NTN cell based on the reference location (e.g., because the first network entity may not otherwise have access to a location of the first network entity at this time due to the lack of location resolution data from a GNSS). This enables the first network entity to obtain and transmit measurement information for one or more NTN cells. The second network entity may use the measurement information to make improved handover decisions for the first network entity. Additionally, based on the measurement information, the first network entity may determine to, or receive an indication to, turn on a GNSS component to proactively obtain the estimated location of the first network entity. This reduces a delay that would otherwise be associated with turning on the GNSS component, obtaining location resolution data, and determining an estimated location of the first network entity after receiving a handover command to an NTN cell. The reduced delay may improve the likelihood of success for the handover to the NTN cell (e.g., due to the reduced risk of the handover failure timer expiring).

Various aspects of the disclosure are described more fully hereinafter with reference to the accompanying drawings. This disclosure may, however, be embodied in many different forms and is not limited to any specific structure, function, example, aspect, or the like presented throughout this disclosure. This disclosure includes, for example, any aspect disclosed herein, whether implemented independently of or combined with any other aspect of the disclosure. For example, an apparatus may be implemented or a method may be practiced using any number of the aspects set forth herein. In addition, the scope of the disclosure includes such an apparatus or method which is practiced using other structure, functionality, or structure and functionality in addition to or other than the various aspects of the disclosure set forth herein. Any aspect of the disclosure disclosed herein may be embodied by one or more elements of a claim.

Aspects and examples generally include a method, apparatus, network node, network entity, system, computer program product, non-transitory computer-readable medium, user equipment, base station, wireless communication device, and/or processing system as described or substantially described herein with reference to and as illustrated by the drawings and specification.

This disclosure may be readily utilized as a basis for modifying or designing other structures for carrying out the same purposes of the present disclosure. Such equivalent constructions do not depart from the scope of the appended claims. Characteristics of the example concepts disclosed herein, both their organization and method of operation, together with associated example advantages, are described in the following description and in connection with the accompanying figures. Each of the figures is provided for the purposes of illustration and description, and not as a definition of the limits of the claims. Each of the figures is provided for the purposes of illustration and description, and not as a definition of the limits of the claims.

While aspects are described in the present disclosure by illustration to some examples, those skilled in the art understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described example aspects and example features may include additional example components and example features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). Aspects described herein may be practiced in a wide variety of devices, components, systems, distributed arrangements, and/or end-user devices of varying size, shape, and constitution.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, Internet of Things (IoT) networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, RF sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

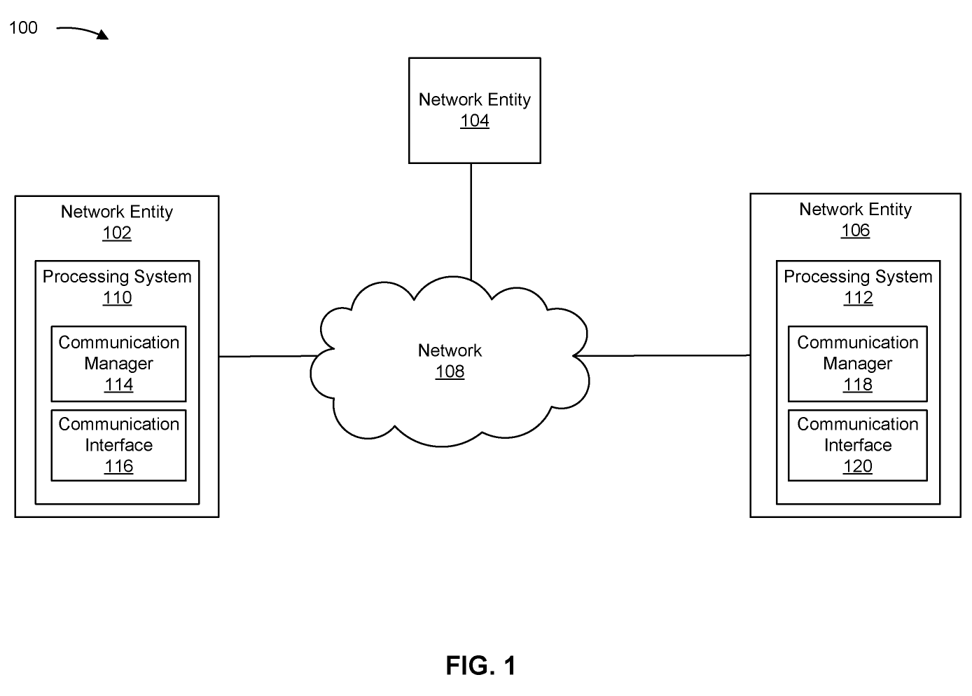

FIG. 1 is a diagram illustrating an example environment 100 in which apparatuses and/or methods described herein may be implemented, in accordance with the present disclosure. As shown in FIG. 1, the environment 100 may include a network entity 102, a network entity 104, and a network entity 106, that may communicate with one another via a network 108. The network entities 102, 104, and 106, may be dispersed throughout the network 108, and each network entity 102, 104, and 106 may be stationary and/or mobile. The network 108 may include wired communication connections, wireless communication connections, or a combination of wired and wireless communication connections.

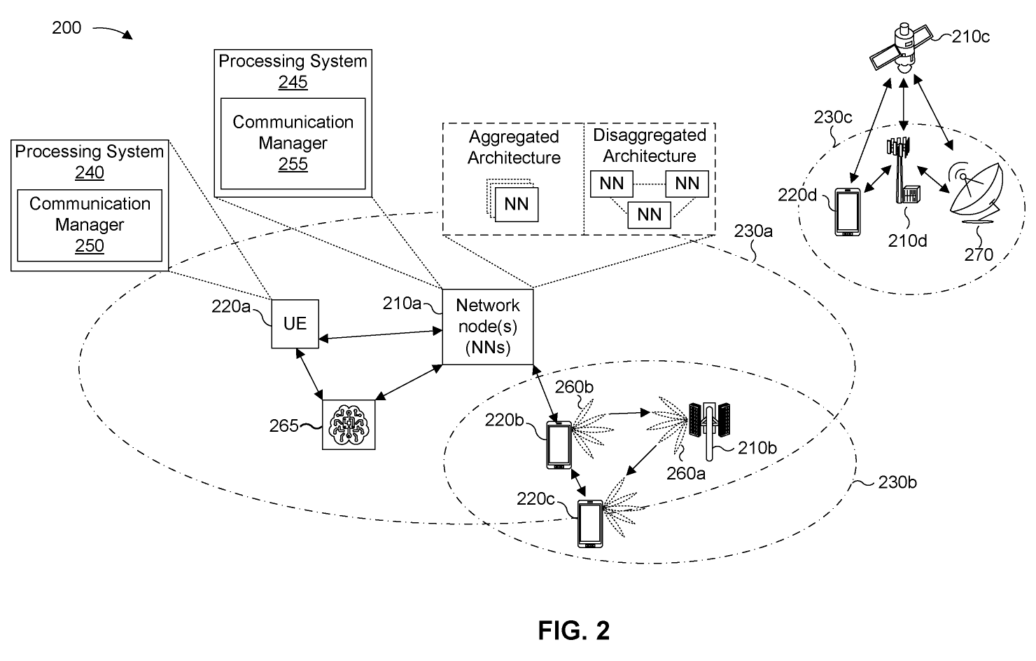

The network 108 may include, for example, a cellular network (e.g., a Long-Term Evolution (LTE) network, a CDMA network, a 4G network, a 5G network, a 6G network, or another type of next generation network, and/or the like), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, or the like, and/or a combination of these or other types of networks. The network 108 may include a wireless communication network 200, described in connection with FIG. 2.

As described herein, a network entity (which may alternatively be referred to as an entity, a node, a network node, or a wireless entity) may be, be similar to, include, or be included in (e.g., be a component of) a base station (e.g., any base station described herein, including a disaggregated base station), a UE (e.g., any UE described herein), a reduced capability (RedCap) device, an enhanced reduced capability (eRedCap) device, an ambient internet-of-things (IoT) device, an energy harvesting (EH)-capable device, a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network entity may be a UE. As another example, a network entity may be a base station. As used herein, “network entity” may refer to an entity that is configured to operate in a network, such as the network 108. For example, a “network entity” is not limited to an entity that is currently located in and/or currently operating in the network. Rather, a network entity may be any entity that is capable of communicating and/or operating in the network. A network entity may include a network node 210 or a UE 220, described in more detail in connection with FIG. 2.

The adjectives “first,” “second,” “third,” and so on are used for contextual distinction between two or more of the modified noun in connection with a discussion and are not meant to be absolute modifiers that apply only to a certain respective entity throughout the entire document. For example, a network entity may be referred to as a “first network entity” in connection with one discussion and may be referred to as a “second network entity” in connection with another discussion, or vice versa. As an example, a first network entity may be configured to communicate with a second network entity or a third network entity. In one aspect of this example, the first network entity may be a UE, the second network entity may be a base station, and the third network entity may be a UE. In another aspect of this example, the first network entity may be a UE, the second network entity may be a base station, and the third network entity may be a base station. In yet other aspects of this example, the first, second, and third network entities may be different relative to these examples.

Similarly, reference to a UE, base station, apparatus, device, computing system, or the like may include disclosure of the UE, base station, apparatus, device, computing system, or the like being a network entity. For example, disclosure that a UE is configured to receive information from a base station also discloses that a first network entity is configured to receive information from a second network entity. Consistent with this disclosure, once a specific example is broadened in accordance with this disclosure (e.g., a UE is configured to receive information from a base station also discloses that a first network entity is configured to receive information from a second network entity), the broader example of the narrower example may be interpreted in the reverse, but in a broad open-ended way. In the example above where a UE is configured to receive information from a base station also discloses that a first network entity is configured to receive information from a second network entity, “first network entity” may refer to a first UE, a first base station, a first apparatus, a first device, a first computing system, a first set of one or more one or more components, a first processing entity, or the like configured to receive the information; and “second network entity” may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network entity may be described as being configured to transmit information to a second network entity. In this example and consistent with this disclosure, disclosure that the first network entity is configured to transmit information to the second network entity includes disclosure that the first network entity is configured to provide, send, output, communicate, or transmit information to the second network entity. Similarly, in this example and consistent with this disclosure, disclosure that the first network entity is configured to transmit information to the second network entity includes disclosure that the second network entity is configured to receive, obtain, or decode the information that is provided, sent, output, communicated, or transmitted by the first network entity.

As shown, the network entity 102 may include a processing system 110. Similarly, the network entity 106 may include a processing system 112. A processing system may include one or more components (or subcomponents), such as one or more components described herein. For example, a respective component of the one or more components may be, be similar to, include, or be included in at least one memory, at least one communication interface, or at least one processor. For example, a processing system may include one or more components. In such an example, the one or more components may include a first component, a second component, and a third component. In this example, the first component may be coupled to a second component and a third component. In this example, the first component may be at least one processor, the second component may be a communication interface, and the third component may be at least one memory. A processing system may generally be a system including one or more components that may perform one or more functions, such as any function or combination of functions described herein. For example, one or more components may receive input information (e.g., any information that is an input, such as a signal, any digital information, or any other information), one or more components may process the input information to generate output information (e.g., any information that is an output, such as a signal or any other information), one or more components may perform any function as described herein, or any combination thereof. A processing system (which may include the processing system 110 and the processing system 112) is described in more detail in connection with FIG. 2, such as in connection with processing system 240 and processing system 245.

As described herein, an “input” and “input information” may be used interchangeably. Similarly, as described herein, an “output” and “output information” may be used interchangeably. Any information generated by any component may be provided to one or more other systems or components of, for example, a network entity described herein. For example, a processing system may include a first component configured to receive or obtain information, a second component configured to process the information to generate output information, and/or a third component configured to provide the output information to other systems or components. In this example, the first component may be a communication interface (e.g., a first communication interface), the second component may be at least one processor (e.g., that is coupled to the communication interface and/or at least one memory), and the third component may be a communication interface (e.g., the first communication interface or a second communication interface). For example, a processing system may include at least one memory, at least one communication interface, and/or at least one processor, where the at least one processor may, for example, be coupled to the at least one memory and the at least one communication interface.

A processing system of a network entity described herein may interface with one or more other components of the network entity, may process information received from one or more other components (such as input information), or may output information to one or more other components. For example, a processing system may include a first component configured to interface with one or more other components of the network entity to receive or obtain information, a second component configured to process the information to generate one or more outputs, and/or a third component configured to output the one or more outputs to one or more other components. In this example, the first component may be a communication interface (e.g., a first communication interface), the second component may be at least one processor (e.g., that is coupled to the communication interface and/or at least one memory), and the third component may be a communication interface (e.g., the first communication interface or a second communication interface). For example, a chip or modem of the network entity may include a processing system. The processing system may include a first communication interface to receive or obtain information, and a second communication interface to output, transmit, or provide information. In some examples, the first communication interface may be an interface configured to receive input information, and the information may be provided to the processing system. In some examples, the second system interface may be configured to transmit information output from the chip or modem. The second communication interface may also obtain or receive input information, and the first communication interface may also output, transmit, or provide information.

For example, as shown in FIG. 1, the processing system 110 may include a (e.g., one or more) communication manager 114 and one or more communication interfaces 116. The communication manager 114 may be configured to perform one or more communication tasks as described herein. In some aspects, the communication manager 114 may direct the communication interface 120 and/or the processing system 110 to perform one or more communication tasks as described herein. Similarly, the processing system 112 may include a (e.g., one or more) communication manager 118 and one or more communication interfaces 120. The communication manager 118 may be configured to perform one or more communication tasks as described herein. In some aspects, the processing system 112 and/or the communication manager 118 may direct the communication interface 120 to perform one or more communication tasks as described herein. Although depicted, for clarity of description, with reference only to the network entities 102 and 104, any one or more of the network entities 102, 104, and 106 also may include a communication manager and a communication interface.

As used herein, “communication interface” refers to an interface that enables communication (e.g., wireless communication, wired communication, or a combination thereof) between a first network entity and a second network entity. A communication interface may include electronic circuitry that enables a network entity to transmit, receive, or otherwise perform the communication. A communication interface may be, be similar to, include, or be included in one or more components that are configured to enable communication between the first network entity and the second network entity. For example, a communication interface may include a transmission component, a reception component, and/or a transceiver, among other examples. For example, a communication interface may include one or more transceivers, one or more receivers, and/or one or more transmitters configured to communicate with other devices, such as via a wired connection, a wireless connection, or a combination of wired and wireless connections. In some examples, a communication interface may include one or more RF components, an RF front end, one or more antennas, one or more transmit or receive processors, a demodulation component, and/or a modulation component, among other examples.

A communication interface may include a transmission component and/or a reception component. For example, a communication interface may include a transceiver and/or one or more separate receivers and/or transmitters that enable a network entity to communicate with other devices, such as via a wired connection, a wireless connection, or a combination of wired and wireless connections. In some examples, a communication interface may include one or more radio frequency reflective elements and/or one or more radio frequency refractive elements. The communication interface may enable the network entity to receive information from another apparatus and/or provide information to another apparatus. In some examples, the communication interface may include an Ethernet interface, an optical interface, a coaxial interface, an infrared interface, an RF interface, a universal serial bus (USB) interface, a Wi-Fi interface, a cellular network interface, a wireless modem, an inter-integrated circuit (I²C), and/or a serial peripheral interface (SPI), among other examples.

As described herein, a network entity (e.g., the network entity 102 and/or the network entity 106) may be configured to perform one or more operations. Reference to a network entity being configured to perform one or more operations may refer to a processing system of the network entity being configured to perform the one or more operations and/or the processing system being configured to cause one or more components of the network entity to perform the one or more operations. For example, reference to the processing system being configured to perform one or more operations may refer to one or more components (or subcomponents) of the processing system performing the one or more operations. For example, the one or more components of the processing system may include at least one memory, at least one processor, and/or at least one communication interface, among other examples, that are configured to perform one or more (or all) of the one or more operations, and/or any combination thereof. Where reference is made to the network entity and/or the processing system being configured to perform operations, the network entity and/or the processing system may be configured to cause one component to perform all operations, or to cause more than one component to collectively perform the operations. When the network entity and/or the processing system is configured to cause more than one component to collectively perform the operations, each operation need not be performed by each of those components (e.g., different operations may be performed by different components) and/or each operation need not be performed in whole by only one component (e.g., different components may perform different sub-functions of an operation).

As described in more detail elsewhere herein, the network entity 102 may (e.g., the processing system 110 may, or the processing system 110 may cause the communication manager 114 and/or the communication interface 116 to) receive, from a second network entity, first information associated with TN-to-NTN mobility, wherein the second network entity is configured to support a terrestrial network cell; and/or perform, in accordance with the first information, an action associated with TN-to-NTN mobility. Additionally, or alternatively, the network entity 102 and/or the communication manager 114 may perform one or more other operations described herein.

As described in more detail elsewhere herein, the network entity 106 may (e.g., the processing system 112 may, or the processing system 112 may cause the communication manager 114 and/or the communication interface 116 to) transmit, to a second network entity, first information associated with TN-to-NTN mobility, wherein the first network entity (e.g., the network entity 106) is configured to support a terrestrial network cell; and/or perform, in accordance with the first information, an action associated with TN-to-NTN mobility. Additionally, or alternatively, the network entity 106 and/or the communication manager 118 may perform one or more other operations described herein.

The number and arrangement of entities shown in FIG. 1 are provided as one or more examples. In practice, there may be additional network entities and/or networks, fewer network entities and/or networks, different network entities and/or networks, or differently arranged network entities and/or networks than those shown in FIG. 1. Furthermore, the network entity 102, 104, and 106 may be implemented using a single apparatus or multiple apparatuses.

FIG. 2 is a diagram illustrating an example of a wireless communication network 200, in accordance with the present disclosure. The wireless communication network 200 may be or may include elements of a 5G (or NR) network or a 6G network, among other examples. The wireless communication network 200 may include multiple network nodes 210. For example, in FIG. 2, the wireless communication network 200 includes a network node (NN) 210a and a network node 210b. The network nodes 210 may support communications with multiple UEs 220. For example, in FIG. 2, the network nodes 210 support communication with a UE 220a, a UE 220b, and a UE 220c. In some examples, a UE 220 may also communicate with other UEs 220 and a network node 210 may communicate with a core network and with other network nodes 210.

The network nodes 210 and the UEs 220 of the wireless communication network 200 may communicate using the electromagnetic spectrum, which may be subdivided by frequency or wavelength into various classes, bands, carriers, and/or channels. For example, devices of the wireless communication network 200 may communicate using one or more operating bands. In some aspects, multiple wireless communication networks 200 may be deployed in a given geographic area. Each wireless communication network 200 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 200 may implement dynamic spectrum sharing (DSS), in which multiple RATs are implemented with dynamic bandwidth allocation (for example, based on user demand) in a single frequency band. In some examples, the wireless communication network 200 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 210 and/or a UE 220 may include one or more devices, components, or systems that enable communication with other devices, components, or systems of the wireless communication network 200. For example, a UE 220 and a network node 210 may each include one or more chips, system-on-chips (SoCs), chipsets, packages, or devices that individually or collectively constitute or comprise a processing system, such as a processing system 240 of the UE 220 or a processing system 245 of the network node 210. The processing system 240 and the processing system 245 may be similar to other processing systems described herein, such as the processing system 110 and the processing system 112. A processing system (for example, the processing system 240 and/or the processing system 245) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 240 and the processing system 245 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 240 and the processing system 245 may each include or be coupled with one or more modems (such as a cellular (for example, a 5G or 6G compliant) modem). In some examples, one or more processors of the processing system 240 and/or the processing system 245 include or implement one or more of the modems. The processing system 240 and the processing system 245 may also include or be coupled with multiple radios (collectively “the radio”), multiple RF chains, or multiple transceivers, each of which may in turn be coupled with one or more of multiple antennas. In some examples, one or more processors of the processing system 240 and/or the processing system 245 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 240 of the UE 220 or by the processing system 245 of the network node 210).

A network node 210 and a UE 220 may each include one or multiple antennas or antenna arrays. Typical network nodes 210 and UEs 220 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 210 and the UE 220.

A network node 210 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 210 may be implemented as a single physical node (for example, a single physical structure) or may be implemented as two or more physical nodes (for example, two or more distinct physical structures). For example, a network node 210 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 210 may be an aggregated network node having an aggregated architecture, meaning that the network node 210 may implement a full radio protocol stack that is physically and logically integrated within a single physical structure in the wireless communication network 200. For example, an aggregated network node 210 may consist of a single standalone base station or a single TRP that operates with a full radio protocol stack to enable or facilitate communication between a UE 220 and a core network of the wireless communication network 200.

Alternatively, and as also shown, a network node 210 may be a disaggregated network node (sometimes referred to as a disaggregated base station), having a disaggregated architecture, meaning that the network node 210 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 210 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 210 of the wireless communication network 200 may include one or more CUs, one or more DUs, and one or more RUs. A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 220. In some examples, a single network node 210 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 210 (for example, a base station, an RU, or a TRP) may provide communication coverage for a particular geographic area. The term “cell” can refer to a coverage area of a network node 210 or to a network node 210 itself, depending on the context in which the term is used. A network node 210 may support one or more cells (for example, each cell may support communication within an angular (for example, 60 degree) range around the network node). In some examples, a network node 210 may provide communication coverage for a macro cell, a pico cell, a femto cell, or another type of cell. A macro cell may cover a relatively large geographic area (for example, several kilometers in radius) and may allow unrestricted access by UEs 220 with associated service subscriptions. A pico cell may cover a relatively small geographic area and may also allow unrestricted access by UEs 220 with associated service subscriptions. A femto cell may cover a relatively small geographic area (for example, a home) and may allow restricted access by UEs 220 having association with the femto cell (for example, UEs 220 in a closed subscriber group (CSG)). In some examples, a cell may not necessarily be stationary. For example, the geographic area of the cell may move according to the location of an associated mobile network node 210 (for example, a train, a satellite, an unmanned aerial vehicle, or an NTN network node).

The wireless communication network 200 may be a heterogeneous network that includes network nodes 210 of different types, such as macro network nodes, pico network nodes, femto network nodes, relay network nodes, aggregated network nodes, and/or disaggregated network nodes, among other examples. Various different types of network nodes 210 may generally transmit at different power levels, serve different coverage areas (for example, a cell 230a and a cell 230b), and/or have different impacts on interference in the wireless communication network 200 than other types of network nodes 210.

As indicated above, a network node 210 may be a terrestrial network node 210 (for example, a terrestrial base station or entity of a disaggregated base station) or an NTN network node 210. In the example shown in FIG. 2, the network node 210c may be an NTN network node 210 and the cell 230c may be an NTN cell. For example, the wireless communication network 200 may include one or more NTN deployments including an NTN network node 210 and/or a relay station. In some examples, a relay station in an NTN deployment may be referred to as a “non-terrestrial relay station.” An NTN may facilitate access to the wireless communication network 200 for remote areas that may not otherwise be within a coverage area of a terrestrial network node 210, such as over water or remote areas in which a terrestrial network is not deployed. An NTN may provide connectivity for various applications, including satellite communications, IoT, MTC, and/or other applications. An NTN network node 210 may include a satellite, a manned aircraft system, or an unmanned aircraft system (UAS) platform, among other examples. A satellite may include a low-earth orbit (LEO) satellite, a medium-earth orbit (MEO) satellite, a geostationary earth orbit (GEO) satellite, and/or a high elliptical orbit (HEO) satellite, among other examples. A manned aircraft system may include an airplane, a helicopter, and/or a dirigible, among other examples. A UAS platform may include a high-altitude platform station (HAPS), a balloon, a dirigible, and/or an airplane, among other examples.

An NTN network node 210 may communicate directly and/or indirectly with other entities in the wireless communication network 200 using NTN communication. The other entities may include UEs 220 (for example, the UE 220d), other NTN network nodes 210 in the one or more NTN deployments, other types of network nodes 210 (for example, stationary, terrestrial, and/or ground-based network nodes, such as the network node 210d), relay stations, and/or one or more components and/or devices included in or coupled with a core network of the wireless communication network 200. For example, an NTN network node 210 may communicate with a UE 220 via a service link (for example, where the service link includes an access link). Additionally or alternatively, an NTN network node 210 may communicate with a gateway 270 (for example, a terrestrial node providing connectivity for the NTN network node 210 to a data network or a core network) via a feeder link (for example, where the feeder link is associated with an N2 or an N3 interface). Additionally or alternatively, NTN network nodes 210 may communicate directly with one another via an inter-satellite link (ISL). In some examples, an NTN deployment may be transparent (for example, where the NTN network node 210 operates in a similar manner as a repeater or relay and/or where an access link does not terminate at the NTN network node 210). In some other examples, an NTN deployment may be regenerative. For example, an access link may terminate at the NTN network node 210, and the NTN network node 210 may regenerate a signal (such as by performing signal processing or enhancement, which may include error correction, modulation or demodulation, or amplification).

The UEs 220 may be physically dispersed throughout the coverage area of the wireless communication network 200, and each UE 220 may be stationary or mobile. A UE 220 may be, may include, or may also be referred to as an access terminal, a mobile station, or a subscriber unit. A UE 220 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 220 may be classified according to different categories in association with different complexities and/or different capabilities. UEs 220 in a first category may facilitate massive IoT in the wireless communication network 200, and may offer low complexity and/or cost relative to UEs 220 in a second category. UEs 220 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 200, among other examples. A third category of UEs 220 may have mid-tier complexity and/or capability (for example, a capability between that of the UEs 220 of the first category and that of the UEs 220 of the second capability). A UE 220 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 210 may be, may include, or may operate as an RU, a TRP, or a base station that communicates with one or more UEs 220 via a radio access link (which may be referred to as a “Uu” link). The radio access link may include a downlink and an uplink. “Downlink” (or “DL”) refers to a communication direction from a network node 210 to a UE 220, and “uplink” (or “UL”) refers to a communication direction from a UE 220 to a network node 210. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 220 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 210 transmitting a downlink control information (DCI) configuration to the one or more UEs 220) and/or reconfigured (for example, in real-time or near-real-time) according to changing network conditions in the wireless communication network 200 and/or specific requirements of one or more UEs 220. An active BWP defines the operating bandwidth of the UE 220 within the operating bandwidth of the serving cell. The use of BWPs enables more efficient use of the available frequency domain resources in the wireless communication network 200 because fewer frequency domain resources may be allocated to a BWP for a UE 220 (which may reduce the quantity of frequency domain resources that a UE 220 is required to monitor and reduce UE power consumption by enabling the UE to monitor fewer frequency domain resources), leaving more frequency domain resources to be spread across multiple UEs 220. Thus, BWPs may also assist in the implementation of lower-capability (for example, RedCap) UEs 220 by facilitating the configuration of smaller bandwidths for communication by such UEs 220 and/or by facilitating reduced UE power consumption.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 210 to a UE 220. DCI generally contains the information the UE 220 needs to identify RBs in a subsequent subframe and how to decode them, including a modulation and coding scheme (MCS) or redundancy version parameters. Different DCI formats carry different information, such as scheduling information in the form of downlink or uplink grants, slot formal indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 220) from a network node 210 to a UE 220. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 220 to a network node 210. An uplink data channel may be used to transmit uplink data (for example, user data associated with a UE 220) from a UE 220 to a network node 210. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 210), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), and/or measurement information (for example, a layer 1 (L1)- reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 210 to a UE 220, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 210 or UE 220 over a wireless communication channel. In some examples, the network node 210 or the UE 220 (for example, using the processing system 245 or the processing system 240, respectively) may select an MCS (for example, an order of quadrature amplitude modulation (QAM), such as 64-QAM, 128-QAM, or 256-QAM, among other examples) for a downlink signal or an uplink signal. For example, the network node 210 may select an MCS for a downlink signal in accordance with UCI received from the UE 220. The network node 210 may transmit, to the UE 220, an indication of the selected MCS for the downlink signal, such as via DCI that schedules the downlink signal. As another example, the network node 210 may transmit, and the UE 220 may receive, an indication of an MCS to be applied for the one or more uplink signals, such as via DCI scheduling transmission of the one or more uplink signals.

The network node 210 or the UE 220 (such as by using the processing system 245 or the processing system 240, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 210 or the UE 220 (for example, using the processing system 245 or the processing system 240, respectively, and/or one or more coupled encoders or modems) may perform a channel coding operation or a forward error correction (FEC) operation to control errors in transmitted information. For example, the network node 210 or the UE 220 may perform an encoding operation to generate encoded information (such as by selectively introducing redundancy into the information, typically using an error correction code (ECC), such as a polar code or a low-density parity-check (LDPC) code). The network node 210 or the UE 220 (for example, using the processing system 245 and/or one or more modems) may further perform spatial processing (for example, precoding) on the encoded information to generate one or more processed or precoded signals for downlink or uplink transmission, respectively. In some examples, the network node 210 or the UE 220 may perform codebook-based precoding or non-codebook-based precoding. Codebook-based precoding may involve selecting a precoder (for example, a precoding matrix) using a codebook. For example, the network node 210 may provide precoding information indicating which precoder, defined by the codebook, is to be used by the UE 220. Non-codebook-based precoding may involve selecting or deriving a precoder based on, or otherwise associated with, one or more downlink or uplink signal measurements. The network node 210 or the UE 220 may transmit the processed downlink or uplink signals, respectively, via one or more antennas.

The network node 210 or the UE 220 may receive uplink signals or downlink signals, respectively, via one or more antennas. The network node 210 or the UE 220 (for example, using the processing system 245 or the processing system 240, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 210 or the UE 220 via the downlink or uplink signals. The network node 210 or the UE 220 (for example, using the processing system 245 or the processing system 240, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 220 and a network node 210 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 210 and/or UE 220 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 210b may generate one or more beams 260a, and the UE 220b may generate one or more beams 260b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 210 and/or at the UE 220, such as in a network implementing mmWave technology. Massive MIMO may improve communication reliability by enabling a network node 210 and/or a UE 220 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 210 and the UE 220 may perform one or more beam management operations, such as an initial beam acquisition operation, one or more beam refinement operations, and/or a beam recovery operation. For example, an initial beam acquisition operation may involve the network node 210 transmitting signals (for example, SSBs, CSI-RSs, or other signals) via respective beams (for example, of the beams 260a of the network node 210) and the UE 220 receiving and measuring the signal(s) via respective beams of multiple beams (for example, from the beams 260b of the UE 220) to identify a best beam (or beam pair) for communication between the UE 220 and the network node 210. For example, the UE 220 may transmit an indication (for example, in a message associated with a random access channel (RACH) operation) of a (best) identified beam of the network node 210 (for example, by indicating an SSBRI or other identifier associated with the beam). A beam refinement operation may involve a first device (for example, the UE 220 or the network node 210) transmitting signal(s) via a subset of beams (for example, identified based on, or otherwise associated with, measurements reported as part of one or more other beam management operations). A second device (for example, the network node 210 or the UE 220) may receive the signal(s) via a single beam (for example, to identify the best beam for communication from the subset of beams). The beam(s) may be identified via one or more spatial parameters, such as a transmission configuration indicator (TCI) state and/or a quasi co-location (QCL) parameter, among other examples. The network node 210 and the UE 220 may increase reliability and/or achieve efficiencies in throughput, signal strength, and/or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 265 (for example, a network node 210 and/or UEs 220). For example, the one or more devices 265 may include a UE 220 (for example, the processing system 240), a network node 210 (for example, the processing system 245), one or more servers, and/or one or more components of a cloud computing network, among other examples. In some examples, the AI/ML model (or an instance of the AI/ML model) may be deployed at multiple devices (for example, a first portion of the AI/ML model may be deployed at a UE 220 and a second portion of the AI/ML model may be deployed at a network node 210). In other examples, a first AI/ML model may be deployed at a UE 220 and a second AI/ML model may be deployed at a network node 210. The AI/ML model(s) may be configured to enhance various aspects of the wireless communication network 200. For example, the AI/ML model(s) may be trained to identify patterns or relationships in data corresponding to the wireless communication network 200, a device, and/or an air interface, among other examples. The AI/ML model(s) may support operational decisions relating to one or more aspects associated with wireless communications devices, networks, or services.

In some aspects, a first network entity (e.g., the UE 220) may include a communication manager 250. As described in more detail elsewhere herein, the communication manager 250 may receive, from a second network entity, first information associated with TN-to-NTN mobility, wherein the second network entity is configured to support a terrestrial network cell (e.g., the cell 230a); and/or perform, in accordance with the first information, an action associated with TN-to-NTN mobility. Additionally, or alternatively, the communication manager 250 may perform one or more other operations described herein.

In some aspects, a first network entity (e.g., the network node 210) may include a communication manager 255. As described in more detail elsewhere herein, the communication manager 255 may transmit, to a second network entity, first information associated with TN-to-NTN mobility, wherein the network node 210 is configured to support a terrestrial network cell (e.g., the cell 230a); and/or perform, in accordance with the first information, an action associated with TN-to-NTN mobility. Additionally, or alternatively, the communication manager 250 may perform one or more other operations described herein.

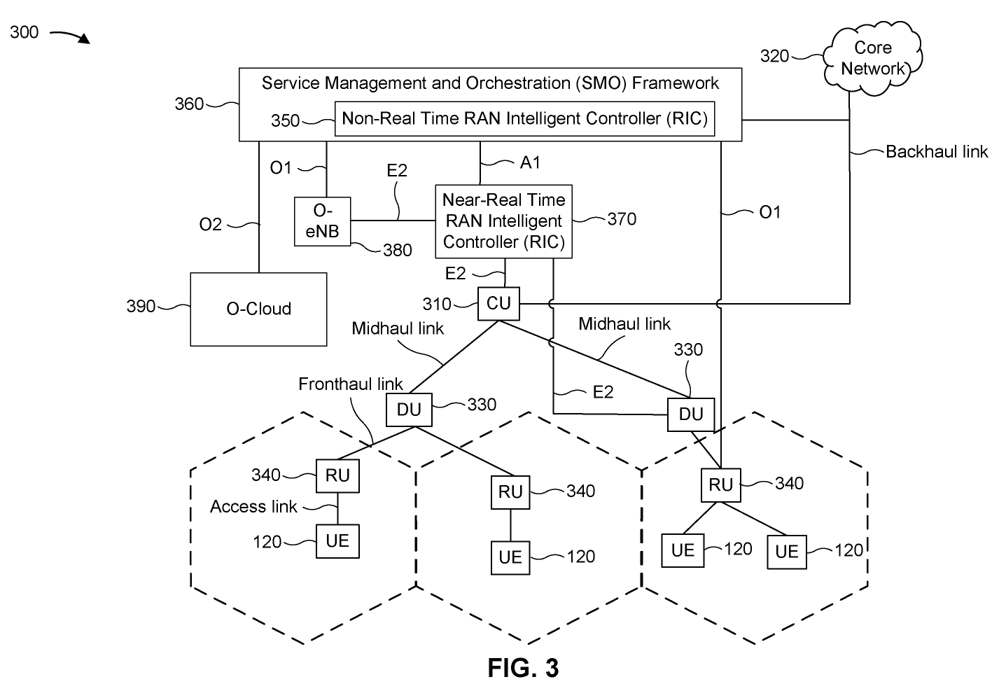

FIG. 3 is a diagram illustrating an example disaggregated network node architecture 300, in accordance with the present disclosure. One or more components of the example disaggregated network node architecture 300 may be, may include, or may be included in one or more network nodes (such one or more network nodes 210). The disaggregated network node architecture 300 may include a CU 310 that can communicate directly with a core network 320 via a backhaul link, or that can communicate indirectly with the core network 320 via one or more disaggregated control units, such as a non-real-time (Non-RT) RAN intelligent controller (RIC) 350 associated with a Service Management and Orchestration (SMO) Framework 360 and/or a near-real-time (Near-RT) RIC 370 (for example, via an E2 link). The CU 310 may communicate with one or more DUs 330 via respective midhaul links, such as via F1 interfaces. Each of the DUs 330 may communicate with one or more RUs 340 via respective fronthaul links. Each of the RUs 340 may communicate with one or more UEs 220 via respective RF access links. In some deployments, a UE 220 may be simultaneously served by multiple RUs 340.

Each of the components of the disaggregated network node architecture 300, including the CUs 310, the DUs 330, the RUs 340, the Near-RT RICs 370, the Non-RT RICs 350, and the SMO Framework 360, may include one or more interfaces or may be coupled with one or more interfaces for receiving or transmitting signals, such as data or information, via a wired or wireless transmission medium.

In some aspects, the CU 310 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 310 may be deployed to communicate with one or more DUs 330, as necessary, for network control and signaling. Each DU 330 may correspond to a logical unit that includes one or more base station functions to control the operation of one or more RUs 340. For example, a DU 330 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 330, or for communicating signals with the control functions hosted by the CU 310. Each RU 340 may implement lower layer functionality. In some aspects, real-time and non-real-time aspects of control and user plane communication with the RU(s) 340 may be controlled by the corresponding DU 330.

The SMO Framework 360 may support RAN deployment and provisioning of non-virtualized and virtualized network elements. For non-virtualized network elements, the SMO Framework 360 may support the deployment of dedicated physical resources for RAN coverage requirements, which may be managed via an operations and maintenance interface, such as an O1 interface. For virtualized network elements, the SMO Framework 360 may interact with a cloud computing platform (such as an open cloud (O-Cloud) platform 390) to perform network element life cycle management (such as to instantiate virtualized network elements) via a cloud computing platform interface, such as an O2 interface. A virtualized network element may include, but is not limited to, a CU 310, a DU 330, an RU 340, a non-RT RIC 350, and/or a Near-RT RIC 370. In some aspects, the SMO Framework 360 may communicate with a hardware aspect of a 4G RAN, a 5G NR RAN, and/or a 6G RAN, such as an open eNB (O-eNB) 380, via an O1 interface. Additionally or alternatively, the SMO Framework 360 may communicate directly with each of one or more RUs 340 via a respective O1 interface. In some deployments, this configuration can enable each DU 330 and the CU 310 to be implemented in a cloud-based RAN architecture, such as a vRAN architecture.

The Non-RT RIC 350 may include or may implement a logical function that enables non-real-time control and optimization of RAN elements and resources, AI/ML workflows including model training and updates, and/or policy-based guidance of applications and/or features in the Near-RT RIC 370. The Non-RT RIC 350 may be coupled to or may communicate with (such as via an A1 interface) the Near-RT RIC 370. The Near-RT RIC 370 may include or may implement a logical function that enables near-real-time control and optimization of RAN elements and resources via data collection and actions via an interface (such as via an E2 interface) connecting one or more CUs 310, one or more DUs 330, and/or an O-eNB 380 with the Near-RT RIC 370.

In some aspects, to generate AI/ML models to be deployed in the Near-RT RIC 370, the Non-RT RIC 350 may receive parameters or external enrichment information from external servers. Such information may be utilized by the Near-RT RIC 370 and may be received at the SMO Framework 360 or the Non-RT RIC 350 from non-network data sources or from network functions. In some examples, the Non-RT RIC 350 or the Near-RT RIC 370 may tune RAN behavior or performance. For example, the Non-RT RIC 350 may monitor long-term trends and patterns for performance and may employ AI/ML models to perform corrective actions via the SMO Framework 360 (such as reconfiguration via an O1 interface) or via creation of RAN management policies (such as A1 interface policies).

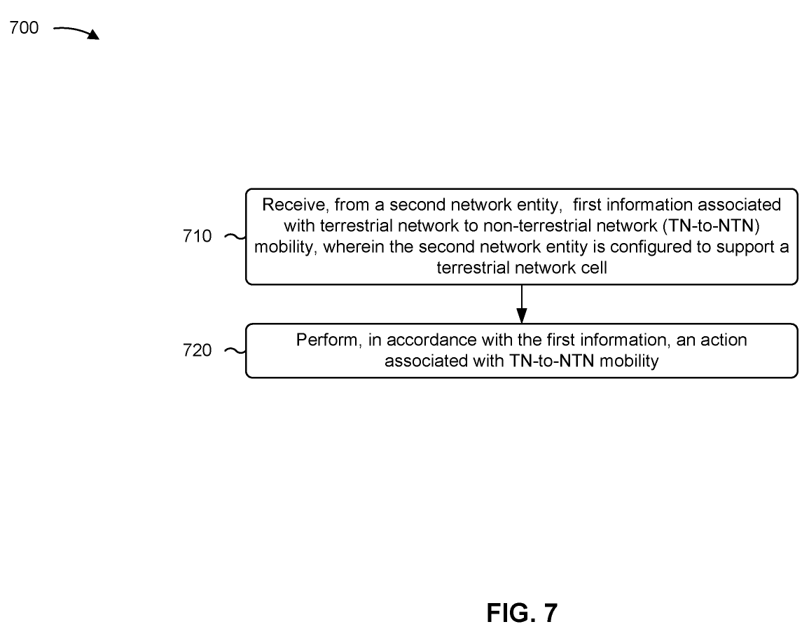

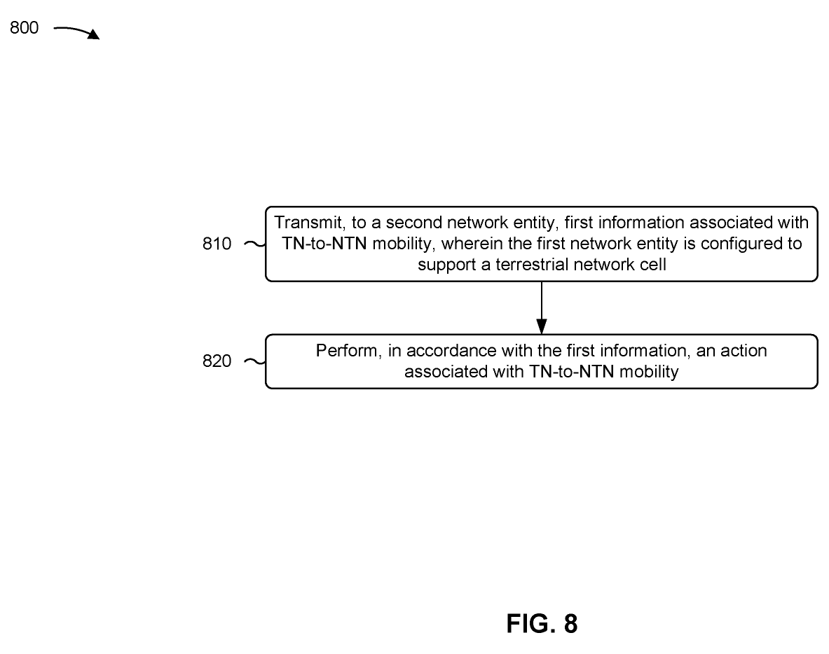

The network entity 102, the processing system 110 of the network entity 102, the network entity 106, the processing system 112 of the network entity 106, the network node 210, the processing system 245 of the network node 210, the UE 220, the processing system 240 of the UE 220, the CU 310, the DU 330, the RU 340, or any other component(s) of FIGS. 1-3 may implement one or more techniques or perform one or more operations associated with TN-to-NTN mobility, as described in more detail elsewhere herein. For example, the processing system 110 of the network entity 102, the processing system 112 of the network entity 106, the processing system 245 of the network node 210, the processing system 240 of the UE 220, the CU 310, the DU 330, or the RU 340 may perform or direct operations of, for example, process 700 of FIG. 7, process 800 of FIG. 8, or other processes as described herein (alone or in conjunction with one or more other processors). Memory of the network node 210 may store data and program code (or instructions) for the network node 210, the CU 310, the DU 330, or the RU 340. In some examples, the memory of the network node 210 may store data relating to a UE 220, such as RRC state information or a UE context. Memory of a UE 220 may store data and program code (or instructions) for the UE 220, such as context information. In some examples, the memory of the UE 220 or the memory of the network node 210 may include a non-transitory computer-readable medium storing a set of instructions for wireless communication. For example, the set of instructions, when executed by one or more processors (for example, of the processing system 110, the processing system 112, the processing system 245, or the processing system 240) of the network entity 102, the network entity 106, the network node 210, the UE 220, the CU 310, the DU 330, or the RU 340, may cause the one or more processors to perform process 700 of FIG. 7, process 800 of FIG. 8, or other processes as described herein. In some examples, executing instructions may include running the instructions, converting the instructions, compiling the instructions, and/or interpreting the instructions, among other examples.

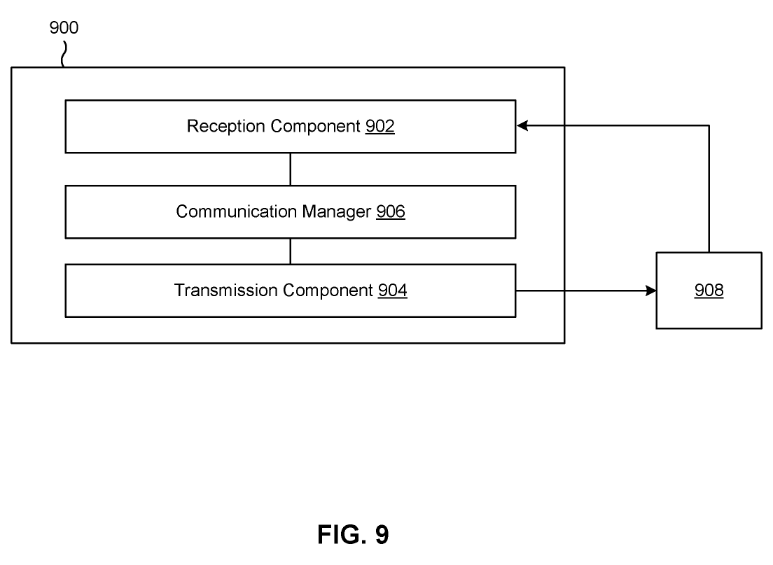

In some aspects, a first network entity includes means for receiving, from a second network entity, first information associated with TN-to-NTN mobility, wherein the second network entity is configured to support a terrestrial network cell; and/or means for performing, in accordance with the first information, an action associated with TN-to-NTN mobility. In some aspects, the means for the first network entity to perform operations described herein may include, for example, one or more of communication manager 250, processing system 240, processing system 110, communication manager 114, communication interface 116, processing system 112, communication manager 118, communication interface 120, a radio, one or more RF chains, one or more transceivers, one or more antennas, one or more modems, a reception component (for example, reception component 902 depicted and described in connection with FIG. 9) and/or a transmission component (for example, transmission component 904 depicted and described in connection with FIG. 9), among other examples.

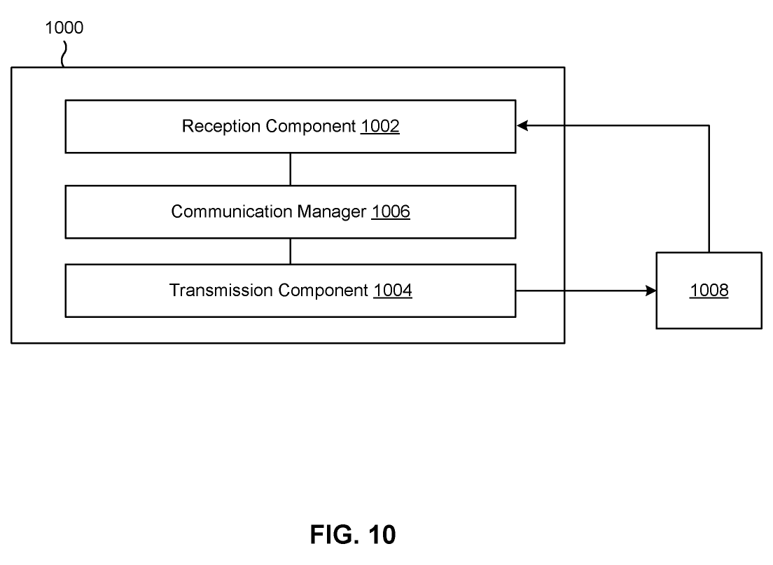

In some aspects, a first network entity includes means for transmitting, to a second network entity, first information associated with TN-to-NTN mobility, wherein the first network entity is configured to support a terrestrial network cell; and/or means for performing, in accordance with the first information, an action associated with TN-to-NTN mobility. In some aspects, the means for the first network entity to perform operations described herein may include, for example, one or more of communication manager 255, processing system 245, processing system 110, communication manager 114, communication interface 116, processing system 112, communication manager 118, communication interface 120, a radio, one or more RF chains, one or more transceivers, one or more antennas, one or more modems, a reception component (for example, reception component 1002 depicted and described in connection with FIG. 10), and/or a transmission component (for example, transmission component 1004 depicted and described in connection with FIG. 10), among other examples.

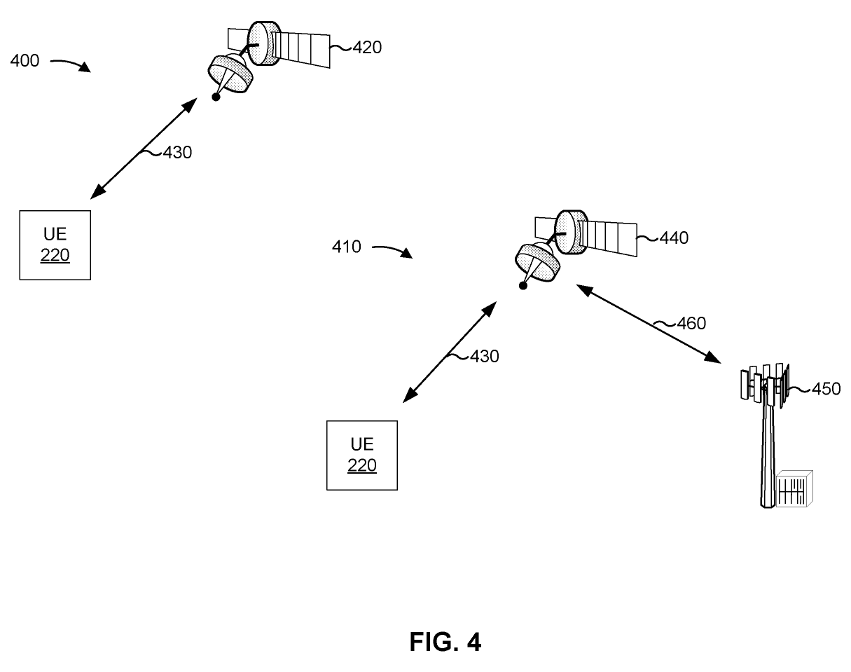

FIG. 4 is a diagram illustrating an example 400 of a regenerative satellite deployment and an example 410 of a transparent satellite deployment in a non-terrestrial network.

Example 400 shows a regenerative satellite deployment. In example 400, a UE 220 is served by a satellite 420 via a service link 430. For example, the satellite 420 may include a network node 210 (e.g., network node 210c) or a gNB. In some examples, the satellite 420 may be referred to as a non-terrestrial base station, a regenerative repeater, or an on-board processing repeater. In some examples, the satellite 420 may demodulate an uplink radio frequency signal, and may modulate a baseband signal derived from the uplink radio signal to produce a downlink radio frequency transmission. The satellite 420 may transmit the downlink radio frequency signal on the service link 430. The satellite 420 may provide a cell that covers the UE 220.

Example 410 shows a transparent satellite deployment, which may also be referred to as a bent-pipe satellite deployment. In example 410, a UE 220 is served by a satellite 440 via the service link 430. The satellite 440 may be a transparent satellite. The satellite 440 may relay a signal received from gateway 450 via a feeder link 460. For example, the satellite may receive an uplink radio frequency transmission, and may transmit a downlink radio frequency transmission without demodulating the uplink radio frequency transmission. In some examples, the satellite may frequency convert the uplink radio frequency transmission received on the service link 430 to a frequency of the uplink radio frequency transmission on the feeder link 460, and may amplify and/or filter the uplink radio frequency transmission. In some examples, the UEs 220 shown in example 400 and example 410 may be associated with a GNSS capability or a Global Positioning System (GPS) capability, though not all UEs have such capabilities. The satellite 440 may provide a cell that covers the UE 220.

The service link 430 may include a link between the satellite 440 and the UE 220, and may include one or more of an uplink or a downlink. The feeder link 460 may include a link between the satellite 440 and the gateway 450, and may include one or more of an uplink (e.g., from the UE 220 to the gateway 450) or a downlink (e.g., from the gateway 450 to the UE 220).

The feeder link 460 and the service link 430 may each experience Doppler effects due to the movement of the satellites 420 and 440, and potentially movement of a UE 220. These Doppler effects may be significantly larger than in a terrestrial network. The Doppler effect on the feeder link 460 may be compensated for to some degree, but may still be associated with some amount of uncompensated frequency error. Furthermore, the gateway 450 may be associated with a residual frequency error, and/or the satellite 420/440 may be associated with an on-board frequency error. These sources of frequency error may cause a received downlink frequency at the UE 220 to drift from a target downlink frequency.

GNSS technology enables a UE (e.g., a UE 220) and/or a network node (e.g., the satellite 420, the satellite 440, the gateway 450, and/or a network node 210) to obtain precise timing and frequency synchronization within wireless communication networks, such as an NTN network and/or the wireless communication network 200. GNSS (e.g., which may include systems, such as GPS, the Galileo navigation satellite system, the BeiDou navigation satellite system, and/or other types of navigation satellite systems) offers highly accurate time and frequency information by utilizing signals from a constellation of orbiting satellites. When a UE possesses GNSS capabilities, the UE can leverage these satellite signals to obtain precise timing information, which can then be used to synchronize an internal clock of the UE. This synchronization facilitates one or more operations, such as handovers, mobility operations, random access procedures, and/or maintaining accurate uplink and downlink transmissions, among other examples. A network node (e.g., the satellite 420, the satellite 440, the gateway 450, and/or a network node 210) can also utilize GNSS signals to achieve a high degree of timing and frequency accuracy. This synchronization allows for coherent communication across a wireless communication network, reducing timing mismatches between network nodes and UEs. By providing a common time reference (such as a coordinated universal time (UTC)), GNSS technology ensures that all devices within the wireless communication network adhere to the same timing standard, which enables the efficient utilization of shared communication resources and advanced features, such as beamforming, carrier aggregation, and/or precise location-based services, among other examples.

In some examples, a UE may operate without access to a GNSS. A UE operating without access to a GNSS may be referred to as a “GNSS-less UE.” For example, the UE may operate in a location resolution operational state. The location resolution operational state may indicate a location resolution capability of the UE and/or a current connection status of the UE to a system via which the UE can obtain or determine a location of the UE, such as a GNSS. For example, the location resolution operational state may indicate that the UE does not support GNSS (e.g., and does not have access to a GNSS). As another example, the location resolution operational state may indicate that the UE supports GNSS, but does not currently have access to a GNSS. As another example, the location resolution operational state may indicate that the UE supports GNSS and currently has access to a GNSS. Although some examples are described herein using GNSS as an example system via which the UE can obtain location information for the UE, the aspects and techniques described herein may be similarly applied for any system via which the UE can obtain location information for the UE, such as a navigation system, a location system, a position, navigation, and timing (PNT) system, and/or a navigation satellite system, among other examples. For example, “location resolution operational state” may be referred to as a location service state, a GNSS operational state, a navigation system operational state, a positioning system operational state, a satellite navigation system operational state, a geo-positioning system status, a location service state, a PNT system status, among other examples. For example, the UE may obtain location resolution data by measuring one or more signals transmitted by a GNSS.

A UE may operate without access to a GNSS because the UE is operating in an area without, or with limited, access to a GNSS, such as in an underground environment (e.g., a tunnel), an indoor environment, a remote environment, and/or in an area for which the GNSS does not provide coverage. As another example, the UE may operate without access to the GNSS in emergency or disaster situations (e.g., in which the GNSS is down or otherwise not providing service for the UE). In some examples, the UE may operate in a location resolution operational state in which the UE does not have access to the GNSS for power savings (e.g., the UE may be capable of communicating with a GNSS, but may operate without accessing the GNSS to conserve power resources).

For example, the UE may operate in an NTN without access to a GNSS. A connection without GNSS may improve coverage for the UE (e.g., instead of, or in addition to, a connection with GNSS), such as for areas or situations without GNSS coverage. While operating in a location resolution operational state without access to a GNSS, the UE and a network node may maintain a closed-loop timing control loop and/or a closed-loop frequency control loop (e.g., may maintain closed-loop timing and frequency adjustments). For example, a timing adjustment and/or frequency adjustment may be maintained by the UE and the network node. The network node may adjust an uplink timing and/or frequency compensation via one or more messages transmitted to the UE, such as a MAC-CE or another type of message.

Additionally, or alternatively, one or more parameters for random access procedures may be defined for UEs operating without access to a GNSS. For example, separate RACH or PRACH resources (e.g., RACH occasions, preambles, or other resources) may be configured for UEs operating without access to a GNSS (e.g., first PRACH resources may be configured for UEs operating without access to a GNSS and second PRACH resources may be configured for UEs operating with access to a GNSS). As another example, a partition of RACH or PRACH resources may be configured for UEs operating without access to a GNSS. This enables RACH or PRACH resources to be configured for the UE that are more robust to timing and/or frequency misalignments, which may be more likely to occur when the UE is operating without access to a GNSS. As another example, the network node may transmit, and the UE (e.g., operating without access to a GNSS) may receive, a random access response (RAR) that includes a frequency adjustment. For example, the UE may expect to receive a frequency adjustment when performing a RACH procedure while operating in a location resolution operational state without access to a GNSS. As another example, the UE may use (e.g., apply) a cell-specific timing adjustment and/or a cell-specific frequency adjustment for transmissions when performing a RACH procedure. For example, cell-specific timing and/or frequency adjustments may be configured and/or indicated for random access for UEs operating without access to a GNSS. As another example, when the UE is operating in a connected mode (e.g., an RRC connected mode), the UE may receive dedicated timing and/or frequency adjustments for random access (e.g., for contention-free random access and/or contention-based random access). The dedicated timing and/or frequency adjustments may be configured for the UE. The dedicated timing and/or frequency adjustments may be cell-specific, UE dedicated, and/or derived from an accumulated frequency adjustment and/or timing adjustment, among other examples.

As indicated above, FIG. 4 is provided as an example. Other examples may differ from what is described with regard to FIG. 4.

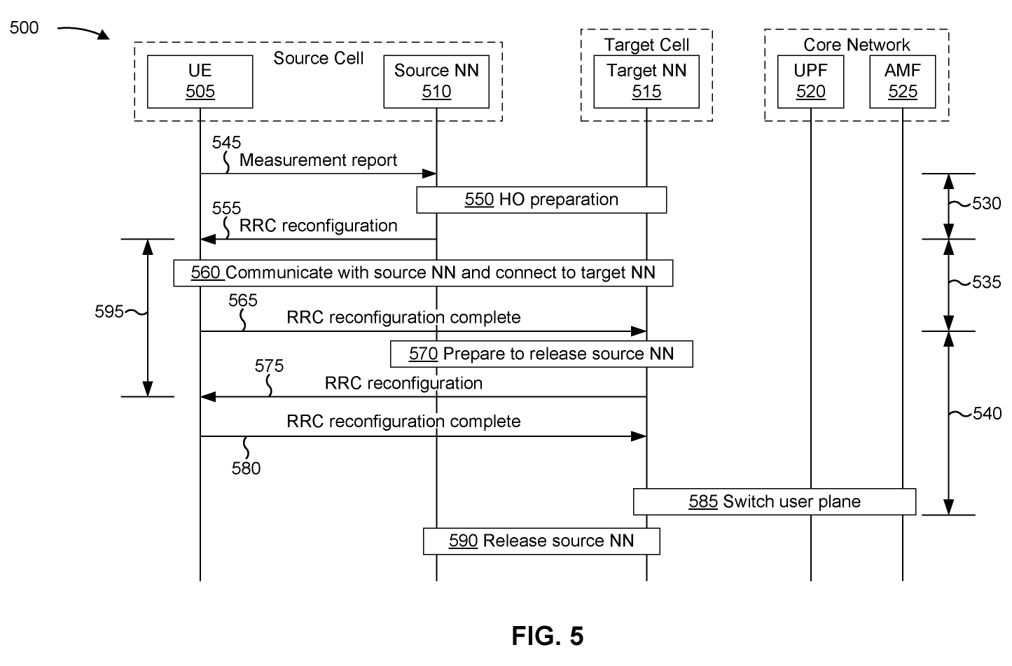

FIG. 5 is a diagram illustrating an example of a handover procedure 500, in accordance with the present disclosure.

The handover procedure 500 may be an example of a make-before-break (MBB) handover procedure. As shown in FIG. 5, the handover procedure 500 may involve a UE 505 (e.g., a UE 220), a source network node 510 (e.g., a network node 210), a target network node 515 (e.g., a network node 210), a user plane function (UPF) device 520, and an access and mobility management function (AMF) device 525. The UPF device 520 and the AMF device 525 are provided as example core network devices. In other examples, another core network device, a function, or a service may perform one or more operations described herein as being performed by the UPF device 520 and/or the AMF device 525.

In some examples, actions described as being performed by a network node may be performed by multiple different network nodes. For example, configuration actions and/or core network communication actions may be performed by a first network node (e.g., a CU or a DU), and radio communication actions may be performed by a second network node (e.g., a DU or an RU). The UE 505 may correspond to the UE 220 described elsewhere herein. The source network node 510 and/or the target network node 515 may correspond to the network node 210 described elsewhere herein. The UE 505 and the source network node 510 may be connected (e.g., may have an RRC connection) via a serving cell or a source cell, and the UE 505 may undergo a handover to the target network node 515 via a target cell. The UPF device 520 and/or the AMF device 525 may be located within a core network. The source network node 510 and the target network node 515 may be in communication with the core network for mobility support and user plane functions. The handover procedure 500 may include an enhanced MBB (eMBB) handover procedure.

As shown, the handover procedure 500 may include a handover preparation phase 530, a handover execution phase 535, and a handover completion phase 540. During the handover preparation phase 530, the UE 505 may report measurements that cause the source network node 510 and/or the target network node 515 to prepare for handover and trigger execution of the handover. During the handover execution phase 535, the UE 505 may execute the handover by performing a random access procedure with the target network node 515 and establishing an RRC connection with the target network node 515. During the handover completion phase 540, the source network node 510 may forward stored communications associated with the UE 505 to the target network node 515, and the UE 505 may be released from a connection with the source network node 510.

As shown by reference number 545, the UE 505 may perform one or more measurements, and may transmit a measurement report to the source network node 510 based at least in part on performing the one or more measurements (e.g., serving cell measurements and/or neighbor cell measurements). The measurement report may indicate, for example, an RSRP parameter, an RSRQ parameter, an RSSI parameter, and/or a signal-to-interference-plus-noise ratio (SINR) parameter (e.g., for the serving cell and/or one or more neighbor cells). The source network node 510 may use the measurement report to determine whether to trigger a handover to the target network node 515. For example, if one or more measurements satisfy a condition, then the source network node 510 may trigger a handover of the UE 505 to the target network node 515.

As shown by reference number 550, the source network node 510 and the target network node 515 may communicate with one another to prepare for a handover of the UE 505. As part of the handover preparation, the source network node 510 may transmit a handover request to the target network node 515 to instruct the target network node 515 to prepare for the handover. The source network node 510 may communicate RRC context information associated with the UE 505 and/or configuration information associated with the UE 505 to the target network node 515. The target network node 515 may prepare for the handover by reserving resources for the UE 505. After reserving the resources, the target network node 515 may transmit an ACK indication to the source network node 510 in response to the handover request.

As shown by reference number 555, the source network node 510 may transmit an RRC reconfiguration message to the UE 505. The RRC reconfiguration message may include a handover command instructing the UE 505 to execute a handover procedure from the source network node 510 to the target network node 515. The handover command may include information associated with the target network node 515, such as a RACH preamble assignment for accessing the target network node 515. Reception of the RRC reconfiguration message, including the handover command, by the UE 505 may trigger the start of the handover execution phase 535.

As shown by reference number 560, during the handover execution phase 535 of the MBB handover, the UE 505 may execute the handover by performing a random access procedure with the target network node 515 (e.g., including synchronization with the target network node 515) while continuing to communicate with the source network node 510. For example, while the UE 505 is performing the random access procedure with the target network node 515, the UE 505 may transmit uplink data, uplink control information, and/or an uplink reference signal (e.g., a sounding reference signal) to the source network node 510, and/or may receive downlink data, downlink control information, and/or a downlink reference signal from the source network node 510.

As shown by reference number 565, upon successfully establishing a connection with the target network node 515 (e.g., via a random access procedure), the UE may transmit an RRC reconfiguration completion message to the target network node 515. Reception of the RRC reconfiguration message by the target network node 515 may trigger the start of the handover completion phase 540.

As shown by reference number 570, the source network node 510 and the target network node 515 may communicate with one another to prepare for release of the connection between the source network node 510 and the UE 505. In some examples, the target network node 515 may determine that a connection between the source network node 510 and the UE 505 is to be released, such as after receiving the RRC reconfiguration message from the UE 505. In this case, the target network node 515 may transmit a handover connection setup completion message to the source network node 510. The handover connection setup completion message may cause the source network node 510 to stop transmitting data to the UE 505 and/or to stop receiving data from the UE 505. Additionally, or alternatively, the handover connection setup completion message may cause the source network node 510 to forward communications associated with the UE 505 to the target network node 515 and/or to notify the target network node 515 of a status of one or more communications with the UE 505. For example, the source network node 510 may forward, to the target network node 515, buffered downlink communications (e.g., downlink data) for the UE 505 and/or uplink communications (e.g., uplink data) received from the UE 505. Additionally, or alternatively, the source network node 510 may notify the target network node 515 regarding a PDCP status associated with the UE 505 and/or a sequence number to be used for a downlink communication with the UE 505.

As shown by reference number 575, the target network node 515 may transmit an RRC reconfiguration message to the UE 505 to instruct the UE 505 to release the connection with the source network node 510. Upon receiving the instruction to release the connection with the source network node 510, the UE 505 may stop communicating with the source network node 510. For example, the UE 505 may refrain from transmitting uplink communications to the source network node 510 and/or may refrain from monitoring for downlink communications from the source network node 510.

As shown by reference number 580, the UE may transmit an RRC reconfiguration completion message to the target network node 515 to indicate that the connection between the source network node 510 and the UE 505 is being released or has been released.

As shown by reference number 585, the target network node 515, the UPF device 520, and/or the AMF device 525 may communicate to switch a user plane path of the UE 505 from the source network node 510 to the target network node 515. Prior to switching the user plane path, downlink communications for the UE 505 may be routed through the core network to the source network node 510. After the user plane path is switched, downlink communications for the UE 505 may be routed through the core network to the target network node 515. Upon completing the switch of the user plane path, the AMF device 525 may transmit an end marker message to the source network node 510 to signal completion of the user plane path switch. As shown by reference number 590, the target network node 515 and the source network node 510 may communicate to release the source network node 510.

As part of the handover procedure 500, the UE 505 may maintain simultaneous connections with the source network node 510 and the target network node 515 during a time period 595. The time period 595 may start at the beginning of the handover execution phase 535 (e.g., upon reception by the UE 505 of a handover command from the source network node 510) when the UE 505 performs a random access procedure with the target network node 515. The time period 595 may end upon release of the connection between the UE 505 and the source network node 510 (e.g., upon reception by the UE 505 of an instruction, from the target network node 515, to release the source network node 510). By maintaining simultaneous connections with the source network node 510 and the target network node 515, the handover procedure can be performed with zero or a minimal interruption to communications, thereby reducing latency.

In some examples, the UE 505, the source network node 510, and/or the target network node 515 may use location resolution data for timing and/or frequency synchronization during the handover procedure 500. However, a dependency on location resolution data for a handover operation imposes challenges, such as when the UE is operating in a location resolution operational state in which the UE does not have access to location resolution data (e.g., due to the UE not supporting a GNSS capability or when the UE is temporarily operating without access to GNSS for one or more reasons, such as power saving). In such examples, the handover operation from a source network node to a target network node may be hindered or degraded by the absence of precise location and timing information, such as when the UE does not have access to location resolution data. This leads to complications in configuring random access resources and/or compensating timing and frequency adjustments during the handover operation. For example, the target network node may assume that the UE has access to location resolution data during the handover operation and/or may not receive location resolution data (e.g., indicating the location or position of the UE) as part of the handover operation. This may degrade performance of the handover operation, such as for scenarios in which there are large timing and/or frequency offsets or adjustments for a communication link (e.g., NTN deployments, high-mobility scenarios (e.g., high-speed-train scenarios), or other scenarios).

For example, the UE 505 may operate in a wireless communication network that supports both terrestrial network cells and NTN cells. In such examples, TN-to-NTN mobility scenarios may exist in which the UE performs a mobility operation for an NTN cell while operating in a terrestrial network cell (e.g., while the terrestrial network cell is the serving cell of the UE). For example, the UE may perform a handover operation from the terrestrial network cell to the NTN cell. Such handovers may be intra-system handovers (e.g., the terrestrial network cell and the NTN cell may be part of the same system and not considered different RATs). As used herein, “TN-to-NTN” mobility refers to a mobility operation for a UE to an NTN cell while a serving cell or source of the UE is a terrestrial network cell. “Serving” cell or “source” cell refers to a cell with which the UE has an active connected connection (e.g., an RRC connected connection). For example, the source network node 510 may be configured to support a terrestrial network cell, such as the cell 230a. The target network node 515 may be configured to support an NTN cell, such as the cell 230c.

In some examples, the UE 505 may be configured to perform measurements for NTN frequencies (e.g., frequencies configured for operation with an NTN cell, such as a cell supported by the target network node 515) for connected mode measurements for a TN-to-NTN mobility operation. However, the UE 505 may not have NTN cell information (e.g., satellite information, ephemeris information, an epoch time, timing advance information, and/or other information) for the NTN frequencies. In such examples, the UE 505 may not perform NTN cell measurements due to the lack of NTN cell information (for example) and may not transmit measurement information for NTN cells to the serving cell of the terrestrial network. In such examples, the source network node 510 may determine to handover the UE to an NTN cell without measurement information for the NTN cell (e.g., a “blind” handover). In such examples, the measurement report described in connection with reference number 545 may not be transmitted by the UE 505 and/or may not include measurement information for the target cell supported by the target network node 515.

The UE 505 operation without location resolution data (e.g., without access to data from a GNSS) may negatively impact the success of a handover from a terrestrial network cell to an NTN cell supported by the target network node 515 (e.g., because the NTN cell may be associated with significant timing and frequency offsets encountered in signal propagation over large distances associated with communication links in the NTN and the UE, and/or the NTN network node may be unable to effectively account for the timing and frequency offsets without the location resolution data). Therefore, in some examples, the UE 505 may obtain location resolution data (e.g., from a GNSS) after receiving a handover command indicating that the UE is to establish a connection with the NTN cell (e.g., as described in connection with reference number 555). However, activating one or more components to enable the UE 505 to communicate or receive signals from the GNSS and establishing a connection with the GNSS may take time. Due to the time associated with obtaining the location resolution data from the GNSS and/or searching for and synchronizing with the NTN cell, a handover failure timer (e.g., a T304 timer as defined, or otherwise fixed, by a wireless communication standard, such as the 3GPP) may expire before the UE is able to successfully complete the handover to the NTN cell, resulting in a failure of the handover.

For example, the UE 505 may initiate the handover failure timer after receiving the RRC reconfiguration message as described in connection with reference number 555. If the handover failure timer expires prior to a successful completion of the handover to the target network node 515, then the handover may fail and the UE 505 may abandon the handover operation. Further, because the serving cell (e.g., the terrestrial network cell supported by the source network node 510) may initiate the handover without measurement information from the UE for the NTN cell, channel conditions between the UE 505 and the NTN cell (e.g., the target cell) may be poor. This may result in the UE 505 being handed over to an unsuitable target cell, degrading performance for the UE and consuming network resources associated with performing the handover operation.

As indicated above, FIG. 5 is provided as an example. Other examples may differ from what is described with respect to FIG. 5.

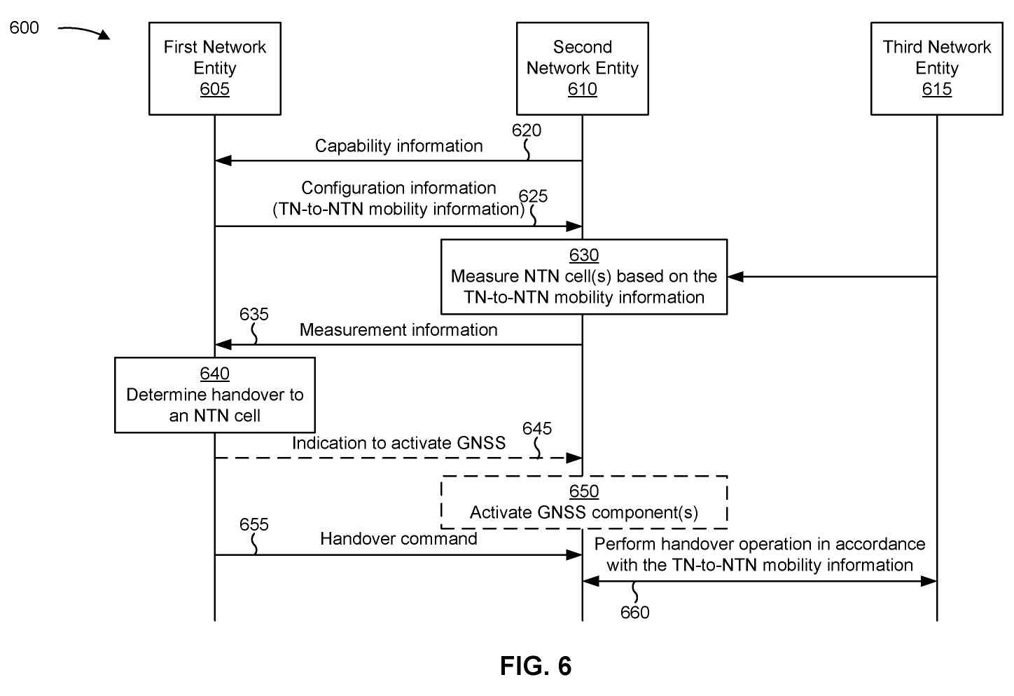

FIG. 6 is a diagram of an example 600 associated with TN-to-NTN mobility, in accordance with the present disclosure. As shown in FIG. 6, a first network entity 605 (e.g., the network entity 102, the network entity 104, the network entity 106, the network node 210, a base station, a CU, a DU, and/or an RU) may communicate with a second network entity 610 (e.g., the network entity 102, the network entity 104, the network entity 106, and/or the UE 220). The first network entity 605 and/or the second network entity 610 may also communicate with a third network entity 615 (e.g., the network entity 102, the network entity 104, the network entity 106, the network node 210, an NTN node, a satellite (e.g., the satellite 420 or the satellite 440) a base station, a CU, a DU, and/or an RU). In some aspects, the first network entity 605, the second network entity 610, and the third network entity 615 may be part of a wireless network (e.g., the wireless communication network 200 or the environment 100).

As used herein, the first network entity 605 “outputting” or “transmitting” a communication to the second network entity 610 may refer to a direct transmission (for example, from the first network entity 605 to the second network entity 610) or an indirect transmission via one or more other network nodes or devices, such as one or more TRPs or access nodes. For example, if the first network entity 605 is a DU or an access node controller, an indirect transmission to the second network entity 610 may include the first network entity 605 outputting or transmitting a communication to an RU (e.g., an access node or a TRP) and the RU transmitting the communication to the second network entity 610, or may include causing the RU to transmit the communication (e.g., triggering transmission of a physical layer reference signal). Similarly, the second network entity 610 “transmitting” a communication to the first network entity 605 may refer to a direct transmission (for example, from the second network entity 610 to the first network entity 605) or an indirect transmission via one or more other network nodes or devices, such as one or more TRPs or access nodes. For example, if the first network entity 605 is a DU or an access node controller, an indirect transmission to the first network entity 605 may include the second network entity 610 transmitting a communication to an RU (e.g., a TRP or an access node) and the RU transmitting the communication to the first network entity 605. Similarly, the first network entity 605 “obtaining” or “receiving” a communication may refer to receiving a transmission carrying the communication directly (for example, from the second network entity 610 to the first network entity 605) or receiving the communication (or information derived from reception of the communication) via one or more other network nodes or devices, such as one or more TRPs or access nodes.

The first network entity 605 and the third network entity 615 may be configured to support one or more cells, such as the cell 230a, the cell 230b, or the cell 230c. In some aspects, the first network entity 605 may be configured to support a terrestrial network cell. For example, the first network entity 605 may be a terrestrial network entity (e.g., a terrestrial network node 210). The first network entity 605 may be a serving or source network entity for the second network entity 610. For example, the second network entity 610 may have an active connected connection (e.g., may be operating in an RRC connected mode) via the terrestrial network cell supported by the first network entity 605. The third network entity 615 may be configured to support an NTN cell, such as the cell 230c. The third network entity 615 may be included in an NTN in a similar manner as described in more detail elsewhere herein, such as in connection with FIGS. 2 and 4. For example, the third network entity 615 may be an NTN network entity, such as the network node 210c, the satellite 420, and/or the satellite 440, among other examples. The third network entity 615 may be a neighbor network entity (e.g., the NTN cell may be a neighbor cell or a candidate cell for handover for the second network entity 610) for the second network entity 610. For example, the second network entity 610 may not have an active connection with the third network entity 615.

In some aspects, as shown by reference number 620, the second network entity 610 may optionally transmit, and the first network entity 605 may receive, capability information. The capability information may be included in a capability report. The second network entity 610 may transmit the capability information via an uplink communication, a sidelink communication, a unicast communication, a broadcast communication, a UE assistance information (UAI) communication, a UCI communication, a sidelink control information (SCI) communication, a MAC-CE communication, an RRC communication, a PUCCH, a PUSCH, a sidelink channel (e.g., a physical sidelink control channel (PSCCH), and/or a physical sidelink shared channel (PSSCH)), among other examples. The capability information may indicate one or more parameters associated with respective capabilities of the second network entity 610. The one or more parameters may be indicated via respective information elements (IEs) included in a capability report.

The capability information may indicate whether the second network entity 610 supports a feature and/or one or more parameters related to the feature. For example, the capability information may indicate a capability and/or parameter for supporting TN-to-NTN mobility (e.g., measurements of an NTN neighbor cell while connected to a terrestrial network cell or TN-to-NTN handover). In some examples, the capability information may indicate a capability and/or parameter for supporting being configured with the TN-to-NTN mobility information described in more detail elsewhere herein. For example, the capability information may indicate that the second network entity 610 supports being configured with a handover failure timer for TN-to-NTN handovers (e.g., a handover failure timer that is only to be used for TN-to-NTN handovers). As an example, the capability information may indicate that the second network entity 610 supports system information (e.g., a system information block (SIB)) that is associated with indicated TN-to-NTN mobility, such as SIB19 as defined, or otherwise fixed, by the 3GPP.

Additionally, or alternatively, the capability information may indicate that the second network entity 610 supports being configured with a reference location (or a proxy location) for NTN cell measurements for TN-to-NTN mobility. In some aspects, the capability information may indicate an amount of time associated with (e.g., needed for) the second network entity 610 activating (e.g., turning on) and/or establishing a connection with a GNSS and/or other location resolution system. Additionally, or alternatively, the capability information may indicate an amount of time associated with (e.g., needed for) the second network entity 610 to synchronize with NTN cells (e.g., for TN-to-NTN mobility). One or more operations described herein may be based on capability information. For example, the second network entity 610 may perform a communication in accordance with the capability information, or may receive configuration information that is in accordance with the capability information.

The first network entity 605 may determine configuration information (e.g., TN-to-NTN mobility information) based on, using, or otherwise associated with the capability information. For example, if the capability information indicates that the second network entity 610 supports the TN-to-NTN mobility information, then the first network entity 605 may determine that the configuration information is to include the TN-to-NTN mobility information. In other examples, the first network entity 605 may determine the configuration information without, or independent of, the capability information. For example, the first network entity 605 may determine that the second network entity 610 supports the TN-to-NTN mobility information as described herein based on a type, category, or other classification of the second network entity 610.

As shown by reference number 625, the first network entity 605 may transmit, and the second network entity 610 may receive, configuration information. In some aspects, the second network entity 610 may receive the configuration information via one or more of system information signaling (e.g., a master information block (MIB) and/or a SIB, among other examples), RRC signaling, MAC signaling (e.g., one or more MAC-CEs), and/or DCI, among other examples.

In some aspects, the configuration information may indicate one or more candidate configurations and/or communication parameters. In some aspects, the one or more candidate configurations and/or communication parameters may be selected, activated, and/or deactivated by a subsequent indication. For example, the subsequent indication may indicate a candidate configuration and/or communication parameter from the one or more candidate configurations and/or communication parameters. In some aspects, the subsequent indication may include a dynamic indication, such as one or more MAC-CEs and/or one or more DCI messages, among other examples.

In some examples, the configuration information may not be expressly signaled to the second network entity 610. For example, in some aspects, the configuration information may at least partially be defined by a wireless communication standard, such as the 3GPP. In such examples, the first network entity 605 may not explicitly indicate such configuration information to the second network entity 610. For example, the second network entity 610 may optionally obtain at least a portion of the configuration information from a configuration stored by the second network entity 610 (e.g., an original equipment manufacturer (OEM) configuration). In some aspects, the configuration information may include a parameter or index that is indicative of information defined, or otherwise fixed, by a wireless communication standard, such as the 3GPP (e.g., rather than explicitly indicating the information).

In some aspects, the configuration information may include TN-to-NTN mobility information (e.g., information associated with TN-to-NTN mobility). “TN-to-NTN mobility information” may refer to information that is configured to facilitate one or more TN-to-NTN mobility operations. For example, the TN-to-NTN information may include handover information configured for TN-to-NTN handovers, such as a handover from a cell supported by the first network entity 605 to a cell supported by the third network entity 615. In some aspects, the TN-to-NTN mobility information may be included in one or more RRC configurations, such as a reconfiguration with synchronization RRC configuration (e.g., indicated via an ReconfigurationWithSync IE), and/or an NTN configuration (e.g., indicated via an NTN-Config IE), among other examples. Additionally, or alternatively, the TN-to-NTN mobility information may be indicated via system information, such as one or more SIBs. For example, the TN-to-NTN mobility information may be indicated via a SIB configured to include satellite assistance information for NTN access, such as SIB19 (e.g., as defined, or otherwise fixed, by the 3GPP).

For example, the TN-to-NTN mobility information may indicate a timer configured for TN-to-NTN handovers. The TN-to-NTN mobility information may include an amount of time or a duration configured for the timer. The timer may be a handover failure timer for TN-to-NTN handovers. For example, the timer may be a reconfiguration with sync failure timer, such as a T304 timer as defined, or otherwise fixed, by the 3GPP. In some aspects, the timer may be specific to TN-to-NTN handovers or RRC reconfigurations. For example, the configuration information may indicate a baseline or default timer (e.g., a T304 timer for TN-to-TN handovers) and the timer configured for TN-to-NTN handovers (e.g., separate handover failure timers for TN-to-NTN handovers and TN-to-TN handovers). For example, the timer configured for TN-to-NTN handovers may be a first timer and the baseline or default timer (e.g., a T304 timer for TN-to-TN handovers) may be a second timer. In some aspects, the first timer may be configured with a longer duration than the second timer. This enables the configuration to account for additional operations and/or time that is associated with a handover operation from a terrestrial network cell to an NTN cell.

In other examples, the timer configured for TN-to-NTN handovers may not be specific to TN-to-NTN handovers. For examples, the timer may be a reconfiguration with sync failure timer, such as the T304 timer. However, the amount of time or duration configured for the timer may be specific to, or configured for, TN-to-NTN handovers. For example, a field or IE for configuring the timer may include a set of options for a duration that can be configured for the timer. In some aspects, a subset of the options, from the set of options, may be for TN-to-NTN handovers. The subset of options may include longer durations from a set of durations indicated by the set of options. For example, a network entity (e.g., a UE) supporting TN-to-NTN handovers may be configured with a larger value (e.g., a longer duration) of the timer (e.g., of the T304 timer) to be applied when a handover is from a terrestrial network cell to an NTN cell. This enables the first network entity 605 to configure a longer duration for the timer when the second network entity 610 is capable of supporting TN-to-NTN handovers.

Additionally, or alternatively, the TN-to-NTN mobility information may indicate an amount of time configured for NTN cell synchronization. The amount of time configured for NTN cell synchronization may be configured to enable the second network entity 610 to perform one or more operations associated with TN-to-NTN mobility. For example, the amount of time may be configured to enable the second network entity 610 to activate (e.g., turn on) a GNSS component and/or establish a connection with a GNSS or other location resolution system. Additionally, or alternatively, the amount of time may be configured to enable the second network entity 610 to perform one or more synchronization operations (e.g., time domain synchronization and/or frequency domain synchronization) with the NTN cell during the handover procedure. The amount of time may be based on a capability of the second network entity 610, such as indicated by the capability information described in connection with reference number 620.

The amount of time configured for NTN cell synchronization may be configured as an offset for the initiation of a handover failure timer (e.g., the T304 timer) for TN-to-NTN handovers. For example, the amount of time configured for NTN cell synchronization may indicate an amount of time after the reception of a reconfiguration message including a reconfiguration with synchronization that the second network entity 610 is to initiate the timer (e.g., after a handover command is received, the start of the timer (e.g., the T304 timer) may be delayed by the amount of time configured for NTN cell synchronization). For example, the second network entity 610 may be configured to initiate the timer after the amount of time from reception of an RRCReconfiguration message including an reconfigurationWithSync IE.

In some aspects, the TN-to-NTN mobility information may include information to facilitate NTN cell measurements for TN-to-NTN mobility. For example, the second network entity 610 may be operating without access to location resolution data (e.g., without an active connection to a GNSS or with a GNSS capability turned off) when operating in the RRC connected with the terrestrial network cell supported by the first network entity 605 (e.g., to save power). Therefore, the second network entity 610 may not have accurate information indicative of a current location of the second network entity 610. The second network entity 610 may be configured to measure one or more frequencies associated with an NTN cell, such as via a measurement object. For example, the second network entity 610 may be configured to measure a frequency associated with (e.g., used by) the NTN cell supported by the third network entity 615.

The TN-to-NTN mobility information may indicate a reference location of the second network entity 610 for the TN-to-NTN mobility. The reference location may also be referred to as a proxy location. The reference location may be configured or indicated to enable the second network entity 610 to have a location estimate or reference to be used to perform a search for and/or measurement of one or more NTN cells. The reference location may be a location of a serving cell. For example, the reference location may be indicated for system information configured for NTN access (e.g., SIB19). The reference location may be a reference location of the serving cell provided via an NTN quasi-Earth fixed system for connected mode measurements. For example, the reference location may be indicated by a referenceLocation IE in a SIB, such as SIB19.

As another example, the reference location may be a location associated with the terrestrial network cell supported by the first network entity 605. For example, the reference location may be a reference location of the terrestrial network cell. In such examples, the reference location may be indicated via system information for the terrestrial network cell, such as via SIB1 as defined, or otherwise fixed, by the 3GPP. As another example, the reference location may be indicated via dedicated RRC signaling for the second network entity 610 (e.g., the first network entity 605 may indicate the reference location for NTN capable network entities via dedicated RRC signaling).

In some aspects, the TN-to-NTN mobility information may indicate one or more conditions, metrics, and/or thresholds to be used by the second network entity 610 to determine whether to turn on a GNSS capability of the second network entity 610. For example, the TN-to-NTN mobility information may include GNSS information indicative of when and/or if the second network entity 610 is to turn on one or more GNSS components and/or establish a connected with a GNSS. For example, the one or more conditions, metrics, and/or thresholds may be associated with measurement information of NTN cells. As an example, the one or more conditions, metrics, and/or thresholds may indicate that if a measurement value of an NTN cell satisfies a threshold (e.g., for a period of time), then the second network entity 610 is to turn on one or more GNSS components and/or establish a connected with a GNSS (e.g., to perform a location resolution operation).

The second network entity 610 may configure itself based on the configuration information. For example, the second network entity 610 may be configured to perform one or more actions described herein based on the configuration information (e.g., the TN-to-NTN mobility information).

As shown by reference number 630, the second network entity 610 may measure one or more NTN cells based on the TN-to-NTN mobility information. For example, the configuration information may indicate one or more NTN frequencies to be measured by the second network entity 610 (e.g., while the second network entity 610 is operating in an RRC connected mode with the first network entity 605). For example, as shown in FIG. 6, the third network entity 615 may transmit one or more signals (e.g., reference signal(s)) via an NTN frequency. The second network entity 610 may measure the one or more signals to obtain measurement information for the NTN cell supported by the third network entity 615.

For example, the second network entity 610 may perform, using the reference location, one or more measurements associated with the NTN cell to obtain measurement information. The measurement information may indicate one or more measurement values, such as one or more RSRP values, RSRQ values, or other measurement values. For example, the second network entity 610 may use the reference location indicated by the TN-to-NTN mobility information as a location of the second network entity 610 when determining the measurement information. This enables the second network entity 610 to obtain or determine more accurate measurement information when the second network entity 610 does not have access to location resolution data (e.g., does not have access to a GNSS).

As shown by reference number 635, the second network entity 610 may transmit, and the first network entity 605 may receive, the measurement information (e.g., associated with the NTN cell). For example, the second network entity 610 may transmit, and the first network entity 605 may receive, a measurement report that includes the measurement information. In some examples, the reference location used by the second network entity 610 may be indicated via a measurement object. In some aspects, the measurement report may indicate whether the second network entity 610 determined the measurement information for the NTN cell(s) using a real (e.g., estimated) location of the second network entity 610 (e.g., from GNSS) or using the reference location.

In some aspects, as shown by reference number 640, the first network entity 605 may determine that the second network entity 610 is to perform a handover to the NTN cell (e.g., supported by the third network entity 615). For example, the first network entity 605 may determine that the second network entity 610 is to perform a handover to the NTN cell based on the measurement information. For example, if one or more measurement values indicated by the measurement information satisfy a threshold, then the first network entity 605 may determine that the second network entity 610 is to perform a handover to the NTN cell (e.g., supported by the third network entity 615). By the first network entity 605 receiving the measurement information, the handover determination for the second network entity 610 to the third network entity 615 may be improved, because the first network entity 605 may trigger the handover based on channel conditions between the second network entity 610 and the NTN cell being satisfactory. In some aspects, the first network entity 605 may attempt to communicate with the third network entity 615 as part of a handover preparation. If the first network entity 605 is unable to establish a connection with the third network entity 615, then the first network entity 605 may refrain from causing the second network entity 610 to be handed over to the third network entity 615. In other words, the first network entity 605 may determine that the second network entity 610 is to perform a handover to the NTN cell based on the first network entity 605 successfully communicating or contacting the third network entity 615.

In some aspects, as shown by reference number 645, the first network entity 605 may transmit, and the second network entity 610 may receive, an indication to perform a location resolution operation (e.g., via an RRC message, a MAC-CE message, a DCI message, or another type of message). The indication to perform the location resolution operation may indicate that the second network entity 610 is to turn on or activate one or more components configured to enable the second network entity 610 to obtain location resolution data from a GNSS (or other system). For example, the first network entity 605 may transmit the indication to perform the location resolution operation based on the measurement information (e.g., based on one or more measurement values indicated by the measurement information satisfying a threshold). Additionally, or alternatively, the first network entity 605 may transmit the indication to perform the location resolution operation based on determining that the second network entity 610 is to perform a handover to the NTN cell.

As another example, and as shown by reference number 650, the second network entity 610 may determine that the second network entity 610 is to perform the location resolution operation (e.g., without receiving instructions from the first network entity 605 to perform the location resolution operation). In other words, the second network entity 610 may autonomously determine to perform the location resolution operation (e.g., to turn on or activate one or more GNSS components). The second network entity 610 may determine that the second network entity 610 is to perform the location resolution operation based on the measurement information (e.g., based on one or more measurement values indicated by the measurement information satisfying a threshold).

This enables the second network entity 610 to turn on or activate one or more components configured to enable the second network entity 610 to obtain location resolution data from a GNSS while the first network entity 605 is preparing the TN-to-NTN handover (e.g., before the first network entity 605 transmits a handover command to the second network entity 610). For example, the second network entity 610 may activate a component of the first network entity (e.g., a component that is configured to enable the first network entity to communicate with a GNSS). The second network entity 610 may perform a location resolution operation to obtain an estimated location of the first network entity (e.g., where the location resolution operation is performed by obtaining data or measuring signals from the GNSS). By the second network entity proactively obtaining location resolution data from the GNSS, a likelihood of the TN-to-NTN handover being successful may be improved because the second network entity 610 may have a more accurate indication of the location of the second network entity 610, and a latency or delay associated with the second network entity 610 obtaining the location resolution data after receiving a handover command may be reduced.

As shown by reference number 655, the first network entity 605 may transmit, and the second network entity 610 may receive, a handover command. The handover command may indicate that the second network entity 610 is to establish a connection with the NTN cell supported by the third network entity 615. The handover command may be included in an RRC message, such as an RRC reconfiguration message with synchronization. In some aspects, the RRC message may include an NTN configuration for the NTN cell, such as a satellite ephemeris, an epoch time, and/or a timing advance value, among other examples.

As shown by reference number 660, the second network entity 610 and the third network entity 615 may perform the handover operation in accordance with the TN-to-NTN mobility information. For example, the TN-to-NTN mobility information may indicate a handover timer configured for TN-to-NTN handovers. The second network entity 610 may initiate the handover failure timer upon receiving the handover command (e.g., as described in connection with reference number 655). Because the handover timer configured for TN-to-NTN handovers may have a relatively longer duration (e.g., than other handover failure timers), a likelihood of success of the handover operation between the second network entity 610 and the third network entity 615 may be improved, because the likelihood of the handover failure timer expiring as a result of operations for TN-to-NTN handovers (such as obtaining location resolution data from a GNSS and/or synchronizing with the NTN cell) may be reduced.

As another example, the TN-to-NTN mobility information may indicate an amount of time configured for NTN cell synchronization. The second network entity 610 may receive the handover command (e.g., described in connection with reference number 655) at a first time. The second network entity 610 may initiate a handover failure timer at a second time (e.g., based on the handover command and based on the third network entity being configured to support the NTN cell). The second time may be offset from the first time by the amount of time configured for NTN cell synchronization. In other words, the second network entity 610 may delay the initiation of the handover failure timer by the amount of time configured for NTN cell synchronization. This provides additional time for the second network entity 610 to perform operations for TN-to-NTN handovers (such as obtaining location resolution data from a GNSS and/or synchronizing with the NTN cell), thereby improving the likelihood of success of the TN-to-NTN handover.

Additionally, because the second network entity 610 may have proactively turned on or activated one or more GNSS components (e.g., and performed a location resolution operation via the GNSS) as described herein, the second network entity 610 may have a more accurate estimated location of the second network entity 610 for use during the handover operation. The more accurate estimated location of the second network entity 610 may improve synchronization operations with the NTN cell, thereby improving the likelihood of success of the handover operation. The second network entity 610 and the third network entity 615 may perform the handover operation in a similar manner as described in more detail elsewhere herein, such as in connection with FIG. 5.

As indicated above, FIG. 6 is provided as an example. Other examples may differ from what is described with respect to FIG. 6.

FIG. 7 is a diagram illustrating an example process 700 performed, for example, at a first network entity or an apparatus of a first network entity, in accordance with the present disclosure. Example process 700 is an example where the apparatus or the first network entity (e.g., the second network entity 610, the network entity 102, and/or the UE 220) performs operations associated with TN-to-NTN mobility.

As shown in FIG. 7, in some aspects, process 700 may include receiving, from a second network entity, first information associated with TN-to-NTN mobility, wherein the second network entity is configured to support a terrestrial network cell (block 710). For example, the first network entity (e.g., using reception component 902 and/or communication manager 906, depicted in FIG. 9) may receive, from a second network entity, first information associated with TN-to-NTN mobility, wherein the second network entity is configured to support a terrestrial network cell, as described above.

As further shown in FIG. 7, in some aspects, process 700 may include performing, in accordance with the first information, an action associated with TN-to-NTN mobility (block 720). For example, the first network entity (e.g., using communication manager 906, depicted in FIG. 9) may perform, in accordance with the first information, an action associated with TN-to-NTN mobility, as described above.

Process 700 may include additional aspects, such as any single aspect or any combination of aspects described below and/or in connection with one or more other processes described elsewhere herein.

In a first aspect, the first information includes handover information configured for TN-to-NTN handovers.

In a second aspect, alone or in combination with the first aspect, the first information indicates a timer configured for TN-to-NTN handovers.

In a third aspect, alone or in combination with one or more of the first and second aspects, the timer is a first timer, and process 700 includes receiving, from the second network entity, second information indicating a second timer configured for handovers.

In a fourth aspect, alone or in combination with one or more of the first through third aspects, the first timer is configured with a longer duration than the second timer.

In a fifth aspect, alone or in combination with one or more of the first through fourth aspects, process 700 includes receiving, from the second network entity, a handover command indicating that the first network entity is to establish a connection with a third network entity, wherein the third network entity is configured to support an NTN cell, and wherein performing the action comprises initiating the timer based on the handover command and based on the third network entity being configured to support the NTN cell.

In a sixth aspect, alone or in combination with one or more of the first through fifth aspects, the first information indicates an amount of time configured for NTN cell synchronization.

In a seventh aspect, alone or in combination with one or more of the first through sixth aspects, process 700 includes receiving, from the second network entity, second information indicating a timer configured for handovers, receiving, from the second network entity and at a first time, a handover command indicating that the first network entity is to establish a connection with a third network entity, wherein the third network entity is configured to support an NTN cell, and wherein performing the action comprises initiating, at a second time, the timer based on the handover command and based on the third network entity being configured to support the NTN cell, wherein the second time is offset from the first time by the amount of time.

In an eighth aspect, alone or in combination with one or more of the first through seventh aspects, process 700 includes transmitting, to the second network entity, capability information associated with NTN cell synchronization, wherein the amount of time is based on the capability information.

In a ninth aspect, alone or in combination with one or more of the first through eighth aspects, the first information indicates a reference location of the first network entity for the TN-to-NTN mobility.

In a tenth aspect, alone or in combination with one or more of the first through ninth aspects, performing the action comprises performing, using the reference location, one or more measurements associated with an NTN cell to obtain measurement information, and transmitting, to the second network entity, the measurement information.

In an eleventh aspect, alone or in combination with one or more of the first through tenth aspects, performing the action comprises performing a location resolution operation to obtain an estimated location of the first network entity.

In a twelfth aspect, alone or in combination with one or more of the first through eleventh aspects, performing the location resolution operation comprises activating a component of the first network entity, wherein the component is configured to enable the first network entity to communicate with a GNSS.

In a thirteenth aspect, alone or in combination with one or more of the first through twelfth aspects, process 700 includes determining, based on the measurement information, to obtain the estimated location of the first network entity.

In a fourteenth aspect, alone or in combination with one or more of the first through thirteenth aspects, process 700 includes receiving, from the second network entity, an indication to obtain the estimated location of the first network entity.

In a fifteenth aspect, alone or in combination with one or more of the first through fourteenth aspects, the first information includes system information configured for NTN access, wherein the reference location is a location of a serving cell, and wherein the system information indicates the reference location.

In a sixteenth aspect, alone or in combination with one or more of the first through fifteenth aspects, the reference location is a location of the terrestrial network cell.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, at a first network entity or an apparatus of a first network entity, in accordance with the present disclosure. Example process 800 is an example where the apparatus or the first network entity (e.g., the first network entity 605, the network entity 106, and/or a network node 210) performs operations associated with TN-to-NTN mobility.

As shown in FIG. 8, in some aspects, process 800 may include transmitting, to a second network entity, first information associated with TN-to-NTN mobility, wherein the first network entity is configured to support a terrestrial network cell (block 810). For example, the first network entity (e.g., using transmission component 1004 and/or communication manager 1006, depicted in FIG. 10) may transmit, to a second network entity, first information associated with TN-to-NTN mobility, wherein the first network entity is configured to support a terrestrial network cell, as described above.

As further shown in FIG. 8, in some aspects, process 800 may include performing, in accordance with the first information, an action associated with TN-to-NTN mobility (block 820). For example, the first network entity (e.g., using communication manager 1006, depicted in FIG. 10) may perform, in accordance with the first information, an action associated with TN-to-NTN mobility, as described above.

Process 800 may include additional aspects, such as any single aspect or any combination of aspects described below and/or in connection with one or more other processes described elsewhere herein.

In a first aspect, the first information includes handover information configured for TN-to-NTN handovers.

In a second aspect, alone or in combination with the first aspect, the first information indicates a timer configured for TN-to-NTN handovers.

In a third aspect, alone or in combination with one or more of the first and second aspects, the timer is a first timer, and process 800 includes transmitting, to the second network entity, second information indicating a second timer configured for handovers.

In a fourth aspect, alone or in combination with one or more of the first through third aspects, the first timer is configured with a longer duration than the second timer.

In a fifth aspect, alone or in combination with one or more of the first through fourth aspects, performing the action comprises transmitting, to the second network entity, a handover command indicating that the second network entity is to establish a connection with a third network entity, wherein the third network entity is configured to support an NTN cell, and wherein the handover command is configured to cause the second network entity to initiate the timer.

In a sixth aspect, alone or in combination with one or more of the first through fifth aspects, the first information indicates an amount of time configured for NTN cell synchronization.

In a seventh aspect, alone or in combination with one or more of the first through sixth aspects, process 800 includes transmitting, to the second network entity, second information indicating a timer configured for handovers, and wherein performing the action comprises transmitting, to the second network entity and at a first time, a handover command indicating that the second network entity is to establish a connection with a third network entity, wherein the third network entity is configured to support an NTN cell, wherein the handover command is configured to cause the second network entity to initiate, at a second time, the timer, and wherein the second time is offset from the first time by the amount of time.

In an eighth aspect, alone or in combination with one or more of the first through seventh aspects, process 800 includes receiving, from the second network entity, capability information associated with NTN cell synchronization, wherein the amount of time is based on the capability information.

In a ninth aspect, alone or in combination with one or more of the first through eighth aspects, the first information indicates a reference location of the first network entity for the TN-to-NTN mobility.

In a tenth aspect, alone or in combination with one or more of the first through ninth aspects, performing the action comprises receiving, from the second network entity, measurement information associated with an NTN cell that is based on the reference location.

In an eleventh aspect, alone or in combination with one or more of the first through tenth aspects, performing the action comprises transmitting, to the second network entity, an indication to obtain an estimated location of the first network entity based on the measurement information.

In a twelfth aspect, alone or in combination with one or more of the first through eleventh aspects, performing the action comprises determining to handover the second network entity from the terrestrial network cell to the NTN cell based on the measurement information, and transmitting, to the second network entity, a handover command indicating that the second network entity is to establish a connection with the NTN cell.

In a thirteenth aspect, alone or in combination with one or more of the first through twelfth aspects, the first information includes system information configured for NTN access, wherein the reference location is a location of a serving cell, and wherein the system information indicates the reference location.

In a fourteenth aspect, alone or in combination with one or more of the first through thirteenth aspects, the reference location is a location of the terrestrial network cell.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication, in accordance with the present disclosure. The apparatus 900 may be a network entity, or a network entity may include the apparatus 900. In some aspects, the apparatus 900 includes a reception component 902, a transmission component 904, and/or a communication manager 906, which may be in communication with one another (for example, via one or more buses and/or one or more other components). In some aspects, the communication manager 906 is the communication manager 114, the communication manager 118, and/or the communication manager 250. As shown, the apparatus 900 may communicate with another apparatus 908, such as a UE or a network node (such as a CU, a DU, an RU, or a base station), using the reception component 902 and the transmission component 904. The communication manager 906 may be included in, or implemented via, a processing system (for example, the processing system 110, the processing system 112, and/or the processing system 240) of the network entity.

In some aspects, the apparatus 900 may be configured to perform one or more operations described herein in connection with FIG. 6. Additionally, or alternatively, the apparatus 900 may be configured to perform one or more processes described herein, such as process 700 of FIG. 7, or a combination thereof. In some aspects, the apparatus 900 and/or one or more components shown in FIG. 9 may include one or more components of the network entity described in connection with FIGS. 1-3. Additionally, or alternatively, one or more components shown in FIG. 9 may be implemented within one or more components described in connection with FIGS. 1-3. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications, and may provide the processed signals to the one or more other components of the apparatus 900. In some aspects, the reception component 902 may include one or more components described above in connection with FIGS. 1-3, such as a radio, one or more RF chains, one or more transceivers, or one or more modems, each of which may in turn be coupled with one or more antennas of the network entity.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications, and may transmit the processed signals to the apparatus 908. In some aspects, the transmission component 904 may include one or more components described above in connection with FIGS. 1-3, such as a radio, one or more RF chains, one or more transceivers, or one or more modems, each of which may in turn be coupled with one or more antennas described in connection with FIGS. 1-3. In some aspects, the transmission component 904 may be co-located with the reception component 902.

The communication manager 906 may support operations of the reception component 902 and/or the transmission component 904. For example, the communication manager 906 may receive information associated with configuring reception of communications by the reception component 902 and/or transmission of communications by the transmission component 904. Additionally, or alternatively, the communication manager 906 may generate and/or provide control information to the reception component 902 and/or the transmission component 904 to control reception and/or transmission of communications.

The reception component 902 may receive, from a second network entity, first information associated with TN-to-NTN mobility, wherein the second network entity is configured to support a terrestrial network cell. The communication manager 906 may perform, in accordance with the first information, an action associated with TN-to-NTN mobility.

The reception component 902 may receive, from the second network entity, a handover command indicating that the first network entity is to establish a connection with a third network entity, wherein the third network entity is configured to support an NTN cell.

The reception component 902 may receive, from the second network entity, second information indicating a timer configured for handovers.

The reception component 902 may receive, from the second network entity and at a first time, a handover command indicating that the first network entity is to establish a connection with a third network entity, wherein the third network entity is configured to support an NTN cell.

The transmission component 904 may transmit, to the second network entity, capability information associated with NTN cell synchronization, wherein the amount of time is based on the capability information.

The communication manager 906 may determine, based on the measurement information, to obtain the estimated location of the first network entity.

The reception component 902 may receive, from the second network entity, an indication to obtain the estimated location of the first network entity.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

FIG. 10 is a diagram of an example apparatus 1000 for wireless communication, in accordance with the present disclosure. The apparatus 1000 may be a network entity, or a network entity may include the apparatus 1000. In some aspects, the apparatus 1000 includes a reception component 1002, a transmission component 1004, and/or a communication manager 1006, which may be in communication with one another (for example, via one or more buses and/or one or more other components). In some aspects, the communication manager 1006 is the communication manager 114, the communication manager 118, and/or the communication manager 255. As shown, the apparatus 1000 may communicate with another apparatus 1008, such as a UE or a network node (such as a CU, a DU, an RU, or a base station), using the reception component 1002 and the transmission component 1004. The communication manager 1006 may be included in, or implemented via, a processing system (for example, the processing system 110, the processing system 112, and/or the processing system 245) of the network entity.

In some aspects, the apparatus 1000 may be configured to perform one or more operations described herein in connection with FIG. 6. Additionally, or alternatively, the apparatus 1000 may be configured to perform one or more processes described herein, such as process 800 of FIG. 8, or a combination thereof. In some aspects, the apparatus 1000 and/or one or more components shown in FIG. 10 may include one or more components described in connection with FIGS. 1-3. Additionally, or alternatively, one or more components shown in FIG. 10 may be implemented within one or more components described in connection with FIGS. 1-3. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications, and may provide the processed signals to the one or more other components of the apparatus 1000. In some aspects, the reception component 1002 may include one or more components described above in connection with FIGS. 1-3, such as a radio, one or more RF chains, one or more transceivers, or one or more modems, each of which may in turn be coupled with one or more antennas of the network entity.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications, and may transmit the processed signals to the apparatus 1008. In some aspects, the transmission component 1004 may include one or more components described above in connection with FIGS. 1-3, such as a radio, one or more RF chains, one or more transceivers, or one or more modems, each of which may in turn be coupled with one or more antennas described in connection with FIGS. 1-3. In some aspects, the transmission component 1004 may be co-located with the reception component 1002.

The communication manager 1006 may support operations of the reception component 1002 and/or the transmission component 1004. For example, the communication manager 1006 may receive information associated with configuring reception of communications by the reception component 1002 and/or transmission of communications by the transmission component 1004. Additionally, or alternatively, the communication manager 1006 may generate and/or provide control information to the reception component 1002 and/or the transmission component 1004 to control reception and/or transmission of communications.

The transmission component 1004 may transmit, to a second network entity, first information associated with TN-to-NTN mobility, wherein the first network entity is configured to support a terrestrial network cell. The communication manager 1006 may perform, in accordance with the first information, an action associated with TN-to-NTN mobility.

The transmission component 1004 may transmit, to the second network entity, second information indicating a timer configured for handovers.

The reception component 1002 may receive, from the second network entity, capability information associated with NTN cell synchronization, wherein the amount of time is based on the capability information.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The following provides an overview of some Aspects of the present disclosure:

Aspect 1: A method of wireless communication performed by a first network entity, comprising: receiving, from a second network entity, first information associated with terrestrial network to non-terrestrial network (TN-to-NTN) mobility, wherein the second network entity is configured to support a terrestrial network cell; and performing, in accordance with the first information, an action associated with TN-to-NTN mobility.

Aspect 2: The method of Aspect 1, wherein the first information includes handover information configured for TN-to-NTN handovers.

Aspect 3: The method of any of Aspects 1-2, wherein the first information indicates a timer configured for TN-to-NTN handovers.

Aspect 4: The method of Aspect 3, wherein the timer is a first timer, and the method further comprising: receiving, from the second network entity, second information indicating a second timer configured for handovers.

Aspect 5: The method of Aspect 4, wherein the first timer is configured with a longer duration than the second timer.

Aspect 6: The method of any of Aspects 3-5, further comprising: receiving, from the second network entity, a handover command indicating that the first network entity is to establish a connection with a third network entity, wherein the third network entity is configured to support a non-terrestrial network (NTN) cell; and wherein performing the action comprises: initiating the timer based on the handover command and based on the third network entity being configured to support the NTN cell. wherein performing the action comprises: initiating the timer based on the handover command and based on the third network entity being configured to support the NTN cell.

Aspect 7: The method of any of Aspects 1-6, wherein the first information indicates an amount of time configured for NTN cell synchronization.

Aspect 8: The method of Aspect 7, further comprising: receiving, from the second network entity, second information indicating a timer configured for handovers; receiving, from the second network entity and at a first time, a handover command indicating that the first network entity is to establish a connection with a third network entity, wherein the third network entity is configured to support an NTN cell; and wherein performing the action comprises: initiating, at a second time, the timer based on the handover command and based on the third network entity being configured to support the NTN cell, wherein the second time is offset from the first time by the amount of time.

Aspect 9: The method of any of Aspects 7-8, further comprising: transmitting, to the second network entity, capability information associated with NTN cell synchronization, wherein the amount of time is based on the capability information.

Aspect 10: The method of any of Aspects 1-9, wherein the first information indicates a reference location of the first network entity for the TN-to-NTN mobility.

Aspect 11: The method of Aspect 10, wherein performing the action comprises: performing, using the reference location, one or more measurements associated with an NTN cell to obtain measurement information; and transmitting, to the second network entity, the measurement information.

Aspect 12: The method of Aspect 11, wherein performing the action comprises: performing a location resolution operation to obtain an estimated location of the first network entity.

Aspect 13: The method of Aspect 12, wherein performing the location resolution operation comprises: activating a component of the first network entity, wherein the component is configured to enable the first network entity to communicate with a global navigation satellite system (GNSS).

Aspect 14: The method of any of Aspects 12-13, further comprising: determining, based on the measurement information, to obtain the estimated location of the first network entity.

Aspect 15: The method of any of Aspects 12-13, further comprising: receiving, from the second network entity, an indication to obtain the estimated location of the first network entity.

Aspect 16: The method of any of Aspects 10-15, wherein the first information includes system information configured for NTN access, wherein the reference location is a location of a serving cell, and wherein the system information indicates the reference location.

Aspect 17: The method of any of Aspects 10-16, wherein the reference location is a location of the terrestrial network cell.

Aspect 18: A method of wireless communication performed by a first network entity, comprising: transmitting, to a second network entity, first information associated with terrestrial network to non-terrestrial network (TN-to-NTN) mobility, wherein the first network entity is configured to support a terrestrial network cell; and performing, in accordance with the first information, an action associated with TN-to-NTN mobility.

Aspect 19: The method of Aspect 18, wherein the first information includes handover information configured for TN-to-NTN handovers.

Aspect 20: The method of any of Aspects 18-19, wherein the first information indicates a timer configured for TN-to-NTN handovers.

Aspect 21: The method of Aspect 20, wherein the timer is a first timer, and the method further comprising: transmitting, to the second network entity, second information indicating a second timer configured for handovers.

Aspect 22: The method of Aspect 21, wherein the first timer is configured with a longer duration than the second timer.

Aspect 23: The method of any of Aspects 20-22, wherein performing the action comprises: transmitting, to the second network entity, a handover command indicating that the second network entity is to establish a connection with a third network entity, wherein the third network entity is configured to support an NTN cell, and wherein the handover command is configured to cause the second network entity to initiate the timer.

Aspect 24: The method of any of Aspects 18-23, wherein the first information indicates an amount of time configured for NTN cell synchronization.

Aspect 25: The method of Aspect 24, further comprising: transmitting, to the second network entity, second information indicating a timer configured for handovers; and wherein performing the action comprises: transmitting, to the second network entity and at a first time, a handover command indicating that the second network entity is to establish a connection with a third network entity, wherein the third network entity is configured to support an NTN cell, wherein the handover command is configured to cause the second network entity to initiate, at a second time, the timer, and wherein the second time is offset from the first time by the amount of time.

Aspect 26: The method of any of Aspects 24-25, further comprising: receiving, from the second network entity, capability information associated with NTN cell synchronization, wherein the amount of time is based on the capability information.

Aspect 27: The method of any of Aspects 18-26, wherein the first information indicates a reference location of the first network entity for the TN-to-NTN mobility.

Aspect 28: The method of Aspect 27, wherein performing the action comprises: receiving, from the second network entity, measurement information associated with an NTN cell that is based on the reference location.

Aspect 29: The method of Aspect 28, wherein performing the action comprises: transmitting, to the second network entity, an indication to obtain an estimated location of the first network entity based on the measurement information.

Aspect 30: The method of any of Aspects 28-29, wherein performing the action comprises: determining to handover the second network entity from the terrestrial network cell to the NTN cell based on the measurement information; and transmitting, to the second network entity, a handover command indicating that the second network entity is to establish a connection with the NTN cell.

Aspect 31: The method of any of Aspects 27-30, wherein the first information includes system information configured for NTN access, wherein the reference location is a location of a serving cell, and wherein the system information indicates the reference location.

Aspect 32: The method of any of Aspects 27-30, wherein the reference location is a location of the terrestrial network cell.

Aspect 33: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-32.

Aspect 34: An apparatus for wireless communication at a device, the apparatus comprising one or more memories and one or more processors coupled to the one or more memories, the one or more processors configured to cause the device to perform the method of one or more of Aspects 1-32.

Aspect 35: An apparatus for wireless communication, the apparatus comprising at least one means for performing the method of one or more of Aspects 1-32.

Aspect 36: A non-transitory computer-readable medium storing code for wireless communication, the code comprising instructions executable by one or more processors to perform the method of one or more of Aspects 1-32.

Aspect 37: A non-transitory computer-readable medium storing a set of instructions for wireless communication, the set of instructions comprising one or more instructions that, when executed by one or more processors of a device, cause the device to perform the method of one or more of Aspects 1-32.

Aspect 38: A device for wireless communication, the device comprising a processing system that includes one or more processors and one or more memories coupled with the one or more processors, the processing system configured to cause the device to perform the method of one or more of Aspects 1-32.

Aspect 39: An apparatus for wireless communication at a device, the apparatus comprising one or more memories and one or more processors coupled to the one or more memories, the one or more processors individually or collectively configured to cause the device to perform the method of one or more of Aspects 1-32.

Aspect 40: A device for wireless communication, the device comprising a processing system, the processing system configured to perform the method of one or more of Aspects 1-32.

Aspect 41: A non-transitory computer-readable medium having code stored thereon that, when executed by a device, causes the device to perform the method of one or more of Aspects 1-32.

The foregoing disclosure provides illustration and description but is neither exhaustive nor limiting of the scope of this disclosure. For example, various aspects and examples are disclosed herein, but this disclosure is not limited to the precise form in which such aspects and examples are described. Modifications and variations may be made in light of the above disclosure or may be acquired from practice of the aspects.

As used herein, the term “component” shall be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. Systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art understand that software and hardware can be designed to implement the systems or methods based, at least in part, on the description herein. A component being configured to perform a function means that the component has a capability to perform the function, and does not require the function to be actually performed by the component, unless noted otherwise.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, the term “determine” or “determining” encompasses a wide variety of actions and, therefore, “determining” can include calculating, computing, processing, deriving, investigating, looking up (such as via looking up in a table, a database or another data structure), inferring, ascertaining, and/or measuring, among other examples. Also, “determining” can include receiving (such as receiving information), accessing (such as accessing data stored in memory), and/or transmitting (such as transmitting information), among other examples. As another example, “determining” can include resolving, selecting, obtaining, choosing, establishing, and/or other such similar actions.

Even though particular combinations of features are recited in the claims and/or disclosed in the specification, these combinations do not limit the scope of the disclosure. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As used herein, a phrase referring to “at least one of” a list of items refers to any combination of those items, including single members. As an example, “at least one of: a, b, or c” covers a, b, c, a + b, a + c, b + c, and a + b + c, as well as any combination with multiples of the same element (for example, a + a, a + a + a, a + a + b, a + a + c, a + b + b, a + c + c, b + b, b + b + b, b + b + c, c + c, and c + c + c, or any other ordering of a, b, and c).

No element, act, or instruction used herein should be construed as critical or essential unless explicitly described as such. Also, as used herein, the articles “a” and “an” include one or more items and may be used interchangeably with “one or more.” Further, as used herein, the article “the” may include one or more items referenced in connection with the article “the” and may be used interchangeably with “the one or more.” Furthermore, as used herein, the terms “set” and “group” may include one or more items and may be used interchangeably with “one or more.” Where only one item is intended, the phrase “only one” or similar language is used. Also, as used herein, the terms “has,” “have,” “having,” and similar terms are open-ended terms that do not limit an element that they modify (for example, an element “having” A may also have B). Further, the phrase “based on” means “based on or otherwise in association with” unless explicitly stated otherwise. Additionally, as used herein, the phrase “based on” shall not be construed as a reference to a closed set of information, one or more conditions, one or more factors, or the like. Also, as used herein, the term “or” is inclusive when used in a series and may be used interchangeably with “and/or,” unless explicitly stated otherwise (for example, if used in combination with “either” or “only one of”). Further, “one or more” may be equivalent to “at least one.”

Even though particular combinations of features are recited in the claims or disclosed in the specification, these combinations are not limiting of the disclosure of various aspects. Many of these features may be combined in ways not specifically recited in the claims or disclosed in the specification. The disclosure of various aspects includes each dependent claim in combination with every other claim in the claim set.

What is claimed is:

1. A first network entity, comprising:
a processing system configured to:
receive, from a second network entity, first information associated with terrestrial network to non-terrestrial network (TN-to-NTN) mobility, wherein the second network entity is configured to support a terrestrial network cell; and
perform, in accordance with the first information, an action associated with TN-to-NTN mobility.

2. The first network entity of claim 1, wherein the first information includes handover information configured for TN-to-NTN handovers.

3. The first network entity of claim 1, wherein the first information indicates a timer configured for TN-to-NTN handovers.

4. The first network entity of claim 3, wherein the timer is a first timer, and wherein the processing system is configured to:
receive, from the second network entity, second information indicating a second timer configured for handovers.

5. The first network entity of claim 4, wherein the first timer is configured with a longer duration than the second timer.

6. The first network entity of claim 3, wherein the processing system is configured to:
receive, from the second network entity, a handover command indicating that the first network entity is to establish a connection with a third network entity, wherein the third network entity is configured to support a non-terrestrial network (NTN) cell; and
wherein, to perform the action, the processing system is configured to:
initiate the timer based on the handover command and based on the third network entity being configured to support the NTN cell.

7. The first network entity of claim 1, wherein the first information indicates an amount of time configured for NTN cell synchronization.

8. The first network entity of claim 7, wherein the processing system is configured to:
receive, from the second network entity, second information indicating a timer configured for handovers;
receive, from the second network entity and at a first time, a handover command indicating that the first network entity is to establish a connection with a third network entity, wherein the third network entity is configured to support an NTN cell; and
wherein, to perform the action, the processing system is configured to:
initiate, at a second time, the timer based on the handover command and based on the third network entity being configured to support the NTN cell, wherein the second time is offset from the first time by the amount of time.

9. The first network entity of claim 7, wherein the processing system is configured to:
transmit, to the second network entity, capability information associated with NTN cell synchronization, wherein the amount of time is based on the capability information.

10. The first network entity of claim 1, wherein the first information indicates a reference location of the first network entity for the TN-to-NTN mobility.

11. The first network entity of claim 10, wherein, to perform the action, the processing system is configured to:
perform, using the reference location, one or more measurements associated with an NTN cell to obtain measurement information; and
transmit, to the second network entity, the measurement information.

12. The first network entity of claim 11, wherein, to perform the action, the processing system is configured to:
perform a location resolution operation to obtain an estimated location of the first network entity.

13. The first network entity of claim 12, wherein, to perform the location resolution operation, the processing system is configured to:
activate a component of the first network entity, wherein the component is configured to enable the first network entity to communicate with a global navigation satellite system (GNSS).

14. The first network entity of claim 12, wherein the processing system is configured to:
determine, based on the measurement information, to obtain the estimated location of the first network entity.

15. The first network entity of claim 12, wherein the processing system is configured to:
receive, from the second network entity, an indication to obtain the estimated location of the first network entity.

16. The first network entity of claim 10, wherein the first information includes system information configured for NTN access, wherein the reference location is a location of a serving cell, and wherein the system information indicates the reference location.

17. The first network entity of claim 10, wherein the reference location is a location of the terrestrial network cell.

18. A first network entity, comprising:
a processing system configured to:
transmit, to a second network entity, first information associated with terrestrial network to non-terrestrial network (TN-to-NTN) mobility, wherein the first network entity is configured to support a terrestrial network cell; and
perform, in accordance with the first information, an action associated with TN-to-NTN mobility.

19. The first network entity of claim 18, wherein the first information includes handover information configured for TN-to-NTN handovers.

20. A method of wireless communication performed by a first network entity, comprising:
receiving, from a second network entity, first information associated with terrestrial network to non-terrestrial network (TN-to-NTN) mobility, wherein the second network entity is configured to support a terrestrial network cell; and
performing, in accordance with the first information, an action associated with TN-to-NTN mobility.
